(19) United States
(12) Patent Application Publication
(10) Pub. No.: US 2015/0047160 A1
(43) Pub. Date: Feb. 19, 2015

(54) Corpse Decay Prevention Method and Corpse Processing Vehicle

(71) Applicants: Office 108 Co., Ltd., Takamatsu-city (JP); Mc Kikisogohanbai K.K., Nakano-ku (JP)

(72) Inventor: Akira Okamoto, Takamatsu-city (JP)

(73) Assignees: MC KIKISOGOHANBAI K.K., Nakano-ku (JP); OFFICE 108 CO., LTD., Takamatsu-city (JP)

(21) Appl. No.: 14/308,655

(22) Filed: Jun. 18, 2014

(30) Foreign Application Priority Data
Aug. 16, 2013 (JP) 2013-169129

(51) Int. Cl. A01N 1/02

(52) U.S. Cl. CPC A01N 1/0284; A01N 1/0294
USPC 27/23.1; 27/22.1

(57) ABSTRACT

A vehicle mounting equipment 10 used for preventing decay of a corpse, wherein the equipment 10 includes: loading and unloading means 20 for loading and unloading the corpse in the vehicle 1, and corpse heating means 30 where the corpse is supplied from the loading and unloading means 20; the corpse heating means 30 including: delivery means for delivering the corpse to and from the loading and unloading means 20, and a heating unit that electromagnetically heats the corpse using electromagnetic waves of a predetermined frequency; and the loading and unloading means 20 including: a transporting unit to deliver the corpse to and from the delivery means of the corpse heating means 30; sterilizing means for sterilizing prior to supplying the loaded corpse to the corpse heating means; and corpse cooling means for cooling a corpse heated by the corpse heating means.

### RELATED APPLICATIONS

This application claims priority and is entitled to the filing date of Japanese Patent Application No. JPA 2013-169129, filed on Aug. 16, 2013, and entitled “Corpse Decay Prevention Method and Corpse Processing Vehicle.” The contents of the aforementioned application are incorporated by reference herein.

### INCORPORATION BY REFERENCE

Applicant hereby incorporates herein by reference any and all patents and published patent applications cited or referred to in this application.

### BACKGROUND OF THE INVENTION

1. Field of the Invention

Aspects of this invention relate generally to devices and methods associated with corpses, and more particularly to corpse decay prevention methods and corpse processing vehicles. The deterioration of the outer appearance, generation of odors and hematemesis due to decay of viscera and the like, must be suppressed in a corpse of a deceased person as much as possible until the time of cremation. The present invention relates to a corpse decay prevention method that can prevent deterioration of the outer appearance, the generation of odors and hematemesis due to the decay of viscera in the corpse, and to a corpse processing vehicle.

2. Description of Related Art

Decay progresses in a corpse when a deceased person's corpse is left as is. The viscera such as a digestive tract and various internal organs of the corpse interior decay particularly easily, and when decay of the viscera progresses, an odor is produced together with a likely occurrence of what is known as hematemesis, which is a discharge of decayed viscera from the mouth of the corpse due to compression of the viscera caused by the generation of decay gases against the abdominal muscles and fat, and therefore, preventing decay of the viscera is extremely important.

Conventionally, dry ice or the like has been used to cool the outside of the corpse in order to suppress decay of the viscera, but techniques have been developed in recent years for conducting decay prevention treatments to prevent progression of decay of viscera.

One prior art technique as disclosed in Japanese Unexamined Patent Application No. 2002-53401 relates to a corpse fluid injection tube for injecting a disinfectant solution or the like into the corpse through a nostril, and as long as the corpse fluid injection tube is used, the disinfectant solution can be supplied to the digestive tract such as the stomach, intestines, and the like that easily decay thereby also disinfecting inside the digestive tract with the disinfectant solution in a similar manner to the corpse surface. Nevertheless, although such techniques can prevent a certain degree of decay of the digestive tract, the decay prevention effect by the disinfectant solution and the like lasts several hours at best but cannot necessarily prevent decay of the viscera and the like until the time of cremation. Furthermore, the disinfectant solution and the like is supplied only to the digestive tract without disinfecting other internal organs outside the digestive tract, for example, the pancreas, liver, kidneys and other internal organs and is thus not able to suppress the progress of decay to those internal organs.

Another prior art technique as disclosed in Japanese Unexamined Patent Application No. 2000-95601 relates to a method for preserving a corpse by replacing the blood of the corpse with an embalming fluid that has a decay prevention effect, and filling the blood vessels of tissues of the corpse with the embalming fluid in place of the blood prevents decay of the tissues of the corpse thereby allowing the corpse to be preserved for a long period of time. Processing the corpse according to such technique can prevent decay of the corpse for several weeks, but treating the corpse takes a significant amount of time and is relatively expensive. Furthermore, even though the time until cremation is at most between three and four days after treating the corpse, a treatment that prevents decay of the corpse for several weeks or more is an excessive process compared to the objective of the treatment and is too expensive relative to the necessary effect. Moreover, replacing the blood with the embalming fluid requires use of a surgical technique that is a treatment that not only damages the corpse but can only be performed by a person having specialized skills such as a doctor.

Further, such prior art techniques are problematic in that they require that the person performing the treatment take steps to contact the corpse, and coming in contact with the corpse has risks in that there are not only bacteria that attach to the corpse after death but also viruses or the like held by the deceased person before death and the person treating the corpse may be infected by these bacteria and viruses. This is the same for when cooling the corpse using dry ice.

Meanwhile, a further prior art technique has been developed in an attempt to resolve the problems associated with the techniques described above as disclosed in Japanese Unexamined Patent Application No. 4152421. With this further prior art technique, the corpse is electromagnetically heated using electromagnetic waves of a predetermined frequency, to raise the temperature of the tissue to at least a temperature that solidifies the proteins that configure the tissue of the corpse interior, and after maintaining the temperature of the tissue to at least a temperature that solidifies the proteins, the corpse is cooled. This technique for heating the corpse can not only solidify the proteins that configure the tissue of the corpse interior but can kill and reduce the bacteria attached to the tissue of the corpse interior. When doing so, since the growth rate of the bacteria attached to the tissue can be suppressed, the decay rate of the tissue of the corpse interior can be slowed even if the temperature of the corpse is reduced after stopping electromagnetic heating. The technique in this reference for heating the corpse can not only solidify the proteins that configure the tissue of the corpse interior but can kill and reduce the bacteria attached to the tissue of the corpse interior. When doing so, since the growth rate of the bacteria attached to the tissue can be suppressed, the decay rate of the tissue of the corpse interior can be slowed even if the temperature of the corpse is reduced after stopping electromagnetic heating.

Thus, use of the technique described in Japanese Unexamined Patent Application No. 4152421 can prevent decay of the tissue of the corpse interior without deterioration of the outer appearance of the corpse for a certain period of time (for example, approximately one day). In other words, it is excellent in regard to being able to suppress damage to the corpse until the time of cremation. However, even this technique cannot prevent the tissue of the corpse interior from decaying without deterioration of the outer appearance over a time period of several days or more. Further, specialized equipment is necessary for processing the corpse using the referenced technique, and during a disaster or the like, it is often difficult to transport the corpse to a location where there is equipment. Also, if transporting takes time, the corpse undergoes further damage during transport and it may not be able to be processed by the equipment. If, during a disaster, the corpse can be processed at the site where the corpse was discovered, the corpse could be processed prior to any further damage and then transported. Doing so would provide a possibility of turning over the corpse to a surviving family member and the like with minimal damage to the corpse.

In light of the foregoing, what is still needed and has heretofore been unavailable is to provide a corpse decay prevention method that can prevent decay of the tissue of the corpse interior over a time period of several days or more without deterioration of the outer appearance of the corpse, and to provide a corpse processing vehicle that can process the corpse on-site using the corpse decay prevention method. Aspects of the present invention fulfill these needs and provide further related advantages as described in the following summary.

### SUMMARY OF THE INVENTION

Aspects of the present invention teach certain benefits in construction and use which give rise to the exemplary advantages described below.

The present invention solves the problems described above by providing a corpse decay prevention method and corpse processing vehicle.

A primary objective inherent in the above described method and vehicle is to provide advantages not taught by the prior art.

Another objective is to provide such a vehicle of a first embodiment mounting equipment used for preventing decay of a corpse, wherein the equipment includes loading and unloading means for loading and unloading the corpse in the vehicle through an opening of the vehicle, and corpse heating means where the corpse is supplied from the loading and unloading means; the corpse heating means includes delivery means for delivering the corpse to and from the loading and unloading means, and a heating unit that electromagnetically heats the corpse from the inside to raise a temperature of the tissue to at least a temperature that solidifies proteins that configure the tissue of the corpse interior and that can hold the temperature of the tissue at least a temperature where protein solidifies; and the loading and unloading means includes a transporting unit to deliver the corpse to and from the delivery means of the corpse heating means, sterilizing means for sterilizing prior to supplying the loaded corpse to the corpse heating means, and corpse cooling means for cooling a corpse heated by the corpse heating means. According to aspects of the first embodiment, loading and unloading a corpse in loading and unloading means through an opening in a vehicle allows the corpse to be moved between corpse heating means and loading and unloading means. Furthermore, sterilization can be performed by sterilizing means and cooling can be performed by corpse cooling means in the loading and unloading means and by electromagnetically heating the corpse using the corpse heating means, the tissue and the like of the corpse will self-heat and thus the corpse can be heated from the inside. Thus, since the various processes are able to prevent the decay of the corpse, damage to the corpse can be slowed. And, since equipment is mounted on a vehicle, the vehicle can be moved to the site where the corpse is and can thus process the corpse. Accordingly, since processing can be done quickly before the corpse is damaged; it is possible to turn a relatively undamaged corpse over to a surviving family member and the like. Furthermore, since the corpse is simply processed through the various means, no special technique is required and thus, as long as the vehicle is moved to the site where the corpse is, anyone can treat the corpse.

Yet another objective is to provide such a corpse processing vehicle of a second embodiment, according to the first embodiment, wherein the loading and unloading means includes a case provided with a space for receiving a corpse inside and having an opening for loading and unloading the corpse to and from the space; and a lid section provided so as to be able to move toward and away from the opening of the case and that blocks the space inside the case from the outside when near the opening of the case; wherein the loading and unloading means is configured to implement sterilization of the corpse by the sterilizing means and cooling of a corpse by the corpse cooling means when the space of the case is blocked from the outside by the lid section. According to aspects of the second embodiment, an opening of a case is blocked by a lid and the various processes are performed on a corpse in the space inside the blocked case and thus corpse processing can be executed safely.

Yet another objective is to provide such a corpse processing vehicle of a third embodiment, according to the first or second embodiments, wherein the sterilizing means has a function to supply ozone and nebulized water droplets into the case while the space inside the case is blocked from the outside by the lid section. According to aspects of the third embodiment, if ozone and a nebulized water droplets are supplied inside the case from the sterilizing means when a corpse is housed in the case, the ozone and nebulized water droplets make contact with the surface of the corpse and thus a sterilizing effect on the corpse surface can be improved. Accordingly, damage to the outer appearance of the corpse can be prevented for a relatively long period of time while decay of the tissue of the corpse interior can be prevented to a certain degree.

Yet another objective is to provide such a corpse processing vehicle of a fourth embodiment, according to the first, second, or third embodiments, further including a physiological saline solution supply means wherein, prior to heating a corpse by the corpse heating means, a physiological saline solution is injected into a digestive tract or into a cavity between the abdominal wall and the digestive tract of the corpse. According to aspects of the fourth invention, if physiological saline solution is injected into a digestive tract of a corpse or into a cavity between the abdominal wall and the digestive tract of the corpse using physiological saline solution supplying means, heating can be done with physiological saline solution in the digestive tract interior and the like. Thus, since a heated condition of the corpse interior is able to approach a uniform state when the corpse is heated using a heating unit of the corpse heating means, decay of and damage to the tissue of the corpse interior can be prevented for a relatively long period of time.

Yet another objective is to provide such a corpse processing vehicle of a fifth embodiment, according to the first, second, third, or fourth embodiments, further including a blocking wall provided with a gate between the loading and unloading means and the corpse heating means for continuously blocking therebetween, and a shielding member, provided on an inside surface of the vehicle, having an electromagnetic wave shielding effect. According to aspects of the fifth embodiment, electromagnetic waves can be prevented from leaking to the outside and thus a corpse can be processed in any location.

Yet another objective is to provide such a corpse decay prevention method of a sixth embodiment comprising a method for preventing decay of a corpse by injecting a physiological saline solution into the digestive tract of the corpse or into a cavity between the abdominal wall and the digestive tract of the corpse, raising a temperature of the tissue to at least a temperature where proteins that configure the tissue of the corpse interior solidify by electromagnetic heating using electromagnetic waves of a predetermined frequency, holding a temperature of the tissue to at least a temperature where protein solidifies, cooling the corpse after electromagnetic heating, and contacting the corpse with air containing ozone and nebulized water droplets. According to aspects of the sixth embodiment, since the tissue of a corpse and the like will self-heat when the corpse is electromagnetically heated, the corpse will be heated from the inside and thus if electromagnetically heated such that the temperature of viscera and the like of the tissue of the corpse interior reaches, for example, 60 degrees or more and then held at that temperature for a predetermined period of time, the proteins that configure the tissue of the corpse interior can be solidified, furthermore, bacteria attached to the tissue of the corpse interior can be killed and reduced. Thus, since the growth rate of bacteria attached to the tissue can be suppressed even if electromagnetic heating is stopped and the temperature of the corpse decreases, the rate of decay of the tissue of the corpse interior can be slowed. The temperature of parts other than the tissue of the corpse interior, in other words, a tissue of the corpse surface, also rises at this time, but the surface of the corpse is in contact with the open air and thus the temperature thereof is lower than that of the corpse interior. Therefore, by adjusting the frequency of electromagnetic waves or the time period of electromagnetic heating, just proteins that configure the tissue of the corpse interior can be solidified while preventing proteins that configure the tissue of the corpse surface from solidifying or, put another way, while preventing the corpse surface from becoming damaged through being discolored or burnt. Furthermore, if the corpse is cooled after being electromagnetically heated such that the temperature of the viscera cools to, for example 20 or less, the amount of time that the temperature of the viscera is within the temperature range (approximately between 20 and 40 degrees) that facilitates growth of bacteria can be shortened and thus, even in cases where the entire tissue of the corpse interior is not completely solidified, the rate of decay of the unsolidified tissue can also be slowed. Furthermore, since ozone and nebulized water droplets are brought into contact with the corpse, a sterilizing effect on the corpse surface can be increased. Accordingly, damage to an outer appearance of the corpse can be prevented for a relatively long period of time while decay of the internal tissue of the corpse can be prevented to a certain degree. Additionally, since only cooling and sterilization are performed after the corpse is electromagnetically heated, a special technique is unnecessary and anyone can perform the treatment of the corpse.

And yet another objective is to provide such a corpse decay prevention method of a seventh embodiment comprising a method for preventing decay of a corpse by injecting a physiological saline solution into the digestive tract of the corpse or into a cavity between the abdominal wall and the digestive tract of the corpse, raising a temperature of the tissue to at least a temperature where proteins that configure the tissue of the corpse interior solidify by electromagnetic heating using electromagnetic waves of a predetermined frequency, holding a temperature of the tissue to at least a temperature where protein solidifies, and cooling the corpse after electromagnetic heating. According to aspects of the seventh embodiment, since the tissue of a corpse and the like will self-heat when the corpse is electromagnetically heated, the corpse will be heated from the inside and thus if electromagnetically heated such that the temperature of viscera and the like of the tissue of the corpse interior reaches, for example, 60 degrees or more and then held at that temperature for a predetermined period of time, proteins that configure the tissue of the corpse interior can be solidified, furthermore, bacteria attached to the tissue of the corpse interior can be killed and reduced. Thus, since the growth rate of bacteria attached to the tissue can be suppressed even if electromagnetic heating is stopped and the temperature of the corpse decreases, the rate of decay of the tissue of the corpse interior can be slowed. The temperature of parts other than the tissue of the corpse interior, in other words, the tissue of a corpse surface, also rises at this time, but the surface of the corpse is in contact with the open air and thus the temperature thereof is lower than that of the corpse interior. Therefore, by adjusting the frequency of electromagnetic waves or the time period of electromagnetic heating, just proteins that configure the tissue of the corpse interior can be solidified while preventing the proteins that configure the tissue of the corpse surface from solidifying or, put another way, while preventing the corpse surface from becoming damaged through becoming discolored or burnt. Furthermore, if the corpse is cooled after being electromagnetically heated such that the temperature of the viscera cools to, for example 20 or less, the amount of time that the temperature of the viscera is within the temperature range (approximately between 20 and 40 degrees) that facilitates growth of bacteria can be shortened and thus, even in cases where the entire tissue of the corpse interior is not completely solidified, the rate of decay of the unsolidified tissue can also be slowed. Additionally, since physiological saline solution is injected into a digestive tract of the corpse or into a cavity between the abdominal wall and the digestive tract of the corpse and then heating is performed, the heated condition of the corpse interior is able to approach a uniform state. Therefore, decay of and damage to the tissue of the corpse interior can be prevented for a relatively long period of time. Additionally, since only cooling is performed after the corpse is electromagnetically heated, special techniques are unnecessary and anyone can perform the treatment of the corpse.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings illustrate aspects of the present invention. In such drawings:

FIG. 1 is a schematic longitudinal cross-sectional view of a cargo compartment 1h in the corpse processing vehicle 1, in accordance with at least one embodiment;

FIG. 2 is a schematic cross-sectional view thereof, in accordance with at least one embodiment, noting that for clarity lid section 25 of loading and unloading means 20 is not shown;

FIGS. 3A and 3B are schematic views for describing an operating condition of the loading and unloading means 20 wherein in FIG. 3A the lid section 25 is in a raised state (the lid section 25 is in a cross-sectional view) and in FIG. 3B the lid section 25 is in a lowered state, in accordance with at least one embodiment;

FIG. 4 is a schematic view of the outer appearance of the corpse processing vehicle 1, in accordance with at least one embodiment; and

FIGS. 5-27 are diagrams illustrating experimental results in connection with exemplary embodiments of the present invention.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION OF THE INVENTION

The above described drawing figures illustrate aspects of the invention in at least one of its exemplary embodiments, which are further defined in detail in the following description.

The corpse processing vehicle of the present invention is a vehicle that can process a corpse at a site where a corpse exists such as the site and the like where a corpse was discovered.

Specifically, the corpse processing vehicle of the present invention mounts equipment that can implement a prevention method that can prevent the decay of the corpse surface and viscera without a special surgical treatment. And, by processing the corpse with this equipment, it is possible to prevent the decay of the corpse and damage to a corpse surface for a certain period of time, for example, of between several days to about a week. Thus, it is possible to prevent damage to the corpse until the corpse is turned over to a surviving family member and the like.

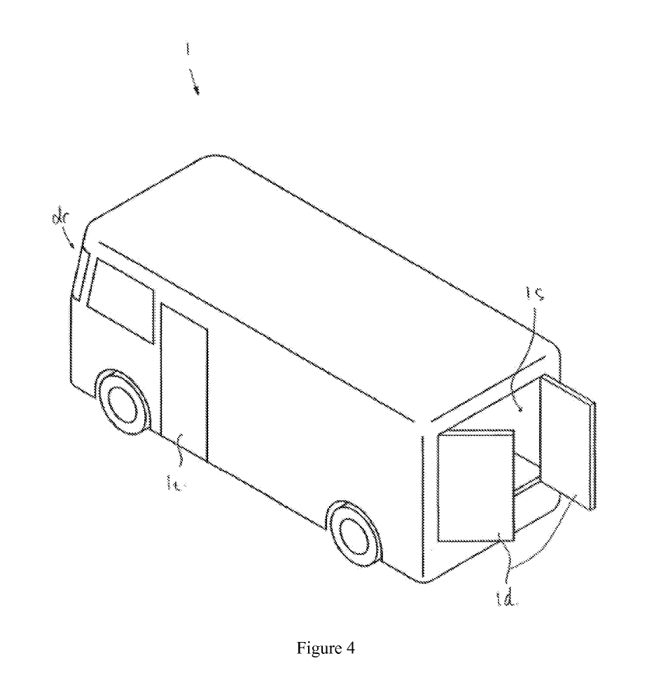

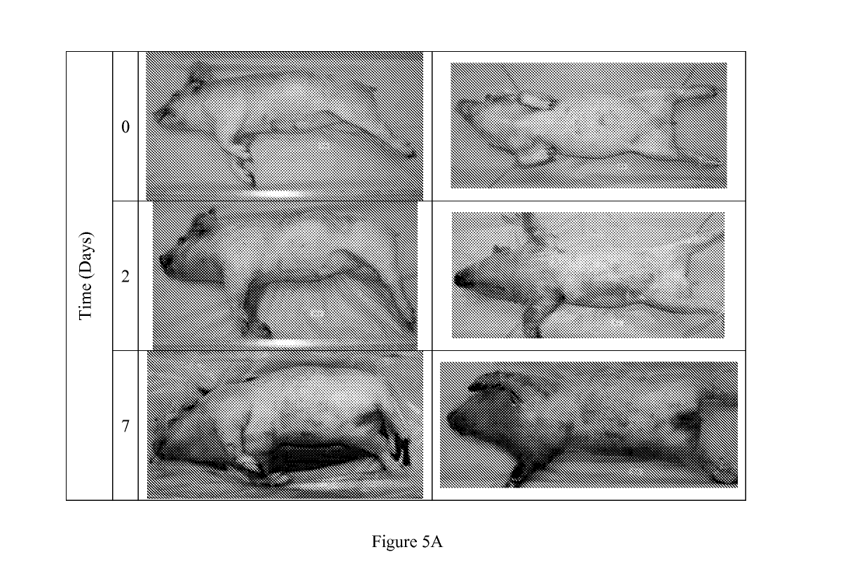

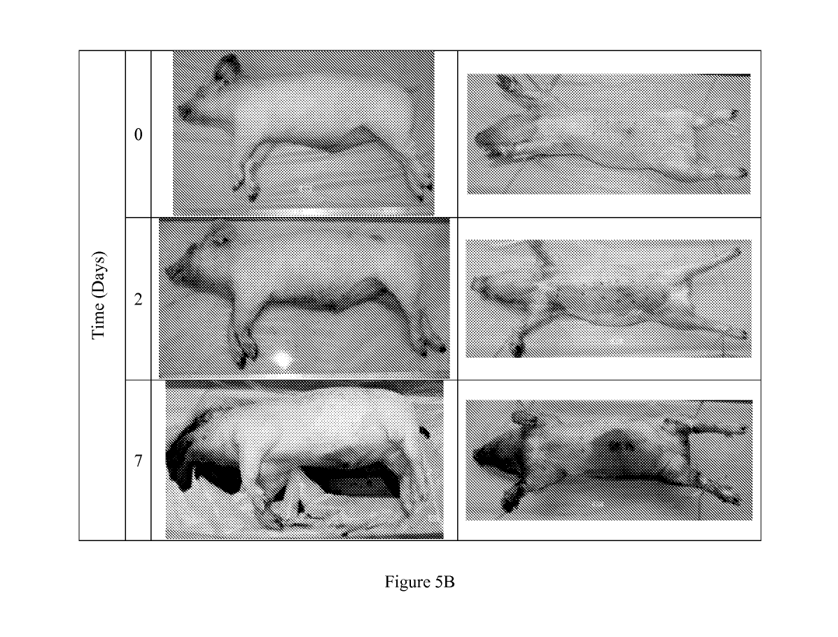

The corpse processing vehicle of the present invention will be described below based on the figures. As illustrated in FIG. 4, the corpse processing vehicle 1 of the present embodiment is a vehicle having a driver's seat dr in front and a door 1d in a rear surface. The corpse processing vehicle 1 of the present embodiment has a cargo compartment 1h that is behind the driver's seat dr. Equipment 10 for processing the corpse is installed in the cargo compartment 1h. The cargo compartment 1h is able to link to the outside through an opening 1s when the rear surface door 1d is opened and the corpse to be processed can be supplied to the equipment 10 through the opening 1s.

In other words, the corpse processing vehicle 1 of the present embodiment is able to supply the corpse to the equipment 10 inside the cargo compartment 1h through the opening 1s when the rear surface door 1d is opened and is able to process the corpse when the inside of the cargo compartment 1h is quarantined from the outside when the rear surface door 1d is closed.

Note that a shielding member having an electromagnetic shielding effect is provided on the inside surface of the corpse processing vehicle 1 of the present embodiment and, in particular, on the inside surface of the cargo compartment 1h. This is to prevent electromagnetic waves released from corpse heating means 30 from leaking to the outside. Since the shielding member is provided, the corpse processing vehicle 1 of the present embodiment is able to process a corpse at any location. Note that, for example, a stainless steel plate and the like can be used for the shielding member but this is not limited thereto as that anything having an effect that can shield electromagnetic waves is acceptable.

Furthermore, while FIG. 4 illustrates an example of the corpse processing vehicle 1 of the present embodiment in a format that opens double doors (a format having a pair of doors 1d and 1d) as the door, there is no particular limitation to the configuration of the door. For example, a single door cantilevered to a vehicle body that swings open horizontally is also acceptable as is a hatch-shaped door that swings upward.

Additionally, FIG. 4 discloses the corpse processing vehicle 1 of the present embodiment in a case where the cargo compartment 1h also has a door 1t in a side surface, but it is acceptable if the cargo compartment 1h does not have a door in a side surface. However, providing a door in a side surface of the cargo compartment 1h achieves an advantage in that maintenance of the equipment inside the cargo compartment 1h is made easier.

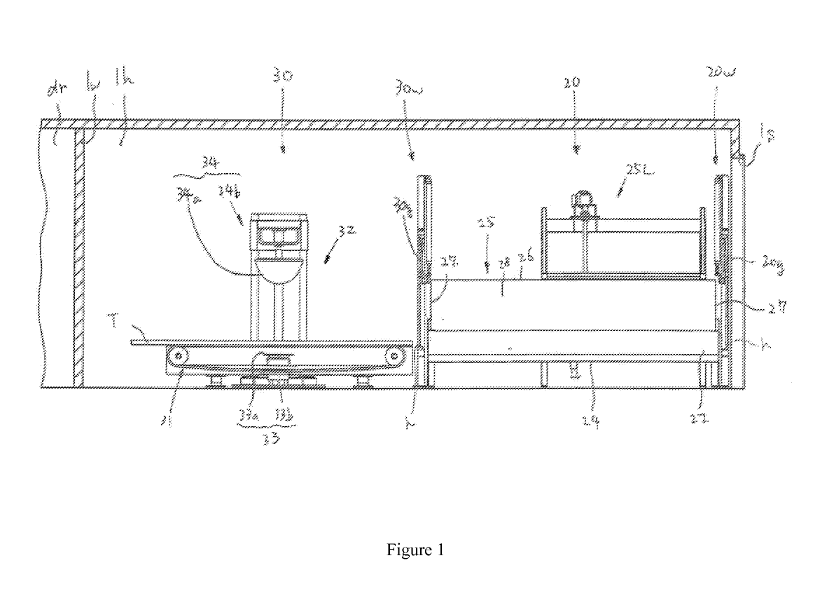

And, a configuration that allows entry to and exit from the driver's seat dr through a side surface door of the cargo compartment 1h is also acceptable. In other words, a shielding wall 1w that shields such that electromagnetic waves released from the equipment 10 do not reach the driver's seat dr is provided between the driver's seat dr and the cargo compartment 1h (refer to FIG. 1). Providing a door in the shielding wall 1w that links the driver's seat dr with the cargo compartment 1h allows a driver or a worker to enter or exit the driver's seat through the side surface door of the cargo compartment 1h and the door of the shielding wall 1w. Thus, since there is no need to provide a door in a side surface of the driver's seat dr, the configuration of the vehicle body can be simplified. And, since the cargo compartment 1h is entered from the driver's seat dr through the door of the shielding wall 1w, it becomes easier to perform work inside the cargo compartment 1h.

The corpse processing vehicle 1 of the present embodiment mounts the equipment 10 for processing the corpse inside the cargo compartment 1h and processing that prevents the decay of the corpse can be performed using the equipment 10.

The equipment 10 that is mounted in the cargo compartment 1h is described below. Furthermore, equipment that loads a corpse in the equipment 10 is not particularly limited as long as the corpse can be placed thereupon and transported thereby. A case using a plate-like tray T is described below in which a through hole Th is formed through which an electrode part 33 can be passed to a position where an abdomen of a corpse is placed.

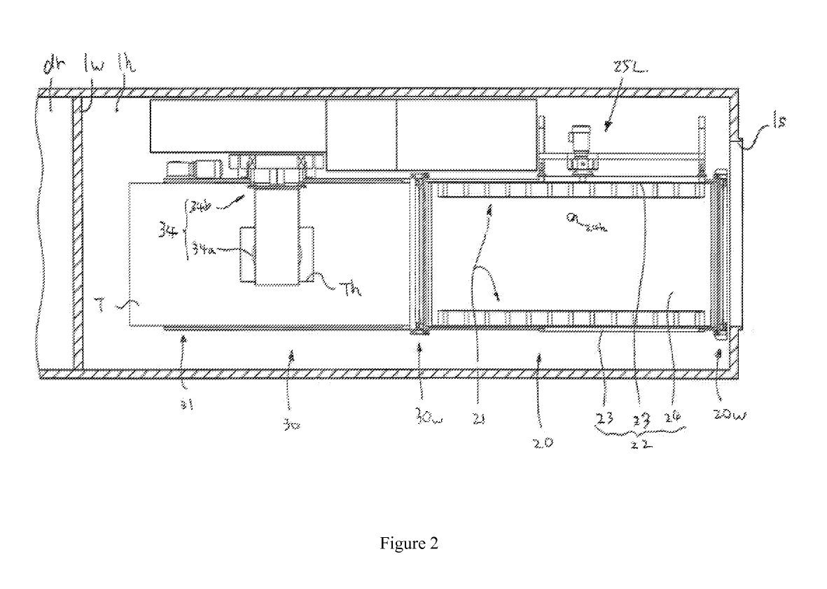

As illustrated in FIG. 1 and FIG. 2, the equipment 10 includes loading and unloading means 20 and the corpse heating means 30. The loading and unloading means 20 and the corpse heating means 30 are provided in that order while being aligned from the opening 1s toward the driver's seat dr.

The corpse heating means 30 heats the corpse from the inside using a heating unit 32 capable of electromagnetic heating in order to prevent the decay of the corpse. A conveyer 31 that is transporting means (in other words, the delivery means described in the Scope of Claims) for transporting the tray T on which the corpse is placed is provided in the corpse heating means 30.

Furthermore, the loading and unloading means 20 includes sterilizing means for sterilizing the loaded corpse and corpse cooling means for cooling the corpse heated by the corpse heating means 30. A conveyer 21 that is a transporting unit or loading unit for transporting the tray T on which the corpse is placed is provided in the loading and unloading means 20 (refer to FIG. 2). The conveyer 21 is provided at about the same height as the conveyer 31 of the corpse heating means 30.

As illustrated in FIG. 1 and FIG. 2, blocking walls 20w and 30w are provided between the loading and unloading means 20 and the corpse heating means 30 and between the loading and unloading means 20 and the opening 1s, respectively. Openings h are formed and gates 20g and 30g that continuously block the openings h are provided in the blocking walls 20w and 30w. Therefore, by opening and closing the gate 20g, the corpse can be loaded and unloaded to and from the outside and the loading and unloading means 20 through the opening h of the blocking wall 20w. Furthermore, by opening and closing the gate 30g, the corpse can be loaded and unloaded to and from the loading and unloading means 20 and the corpse heating means 30 through the opening h of the blocking wall 30w.

Note that, in the example illustrated in FIG. 1 and FIG. 2, the configuration is such that the openings h are opened and closed by moving plate-like gates 20g and 30g up and down with a cylinder mechanism, but the configuration for opening and closing the openings h is not particularly limited and thus various well-known mechanisms can be used.

Furthermore, the blocking walls 20w and 30w in FIG. 1 and FIG. 2 are configured such that complete separation between the loading and unloading means 20 and the outside and between the loading and unloading means 20 and the corpse heating means 30 is not possible. However, a certain degree of separation between the loading and unloading means 20 and the outside and between the loading and unloading means 20 and the corpse heating means 30 is possible even with the blocking walls 20w and 30w in FIG. 1 and FIG. 2. Accordingly, leakage of the electromagnetic waves emitted from the corpse heating means 30 and the ozone used by the loading and unloading means 20 and the like into other areas can be prevented to a certain degree. Of course, something that allows complete separation between the loading and unloading means 20 and the outside and between the loading and unloading means 20 and the corpse heating means 30 may be used as the blocking walls 20w and 30w. Furthermore, a separating wall that completely separates the cargo compartment 1h may be provided in the blocking wall 20w and, on the other hand, something like that illustrated in FIG. 1 and FIG. 2 (something that does not allow complete separation between the loading and unloading means 20 and the outside) may be provided in the blocking wall 30w. And, if the processing of the various means and the movement of the corpse between the various means can automated, processing of the corpse can be done when the equipment 10 is blocked from the outside when the door 1d is closed after the corpse is loaded and thus the blocking walls 20w and 30w need not be provided in this case. In other words, if it is not necessary to open door 1d until all processing is completed when the corpse is loaded, the blocking walls 20w and 30w need not be provided.

Corpse processing in the equipment 10 will be described next. First, the corpse placed on the tray T is loaded in the loading and unloading means 20 through the opening 1s and the opening h of the blocking wall 20w. Then, the tray T is placed on the conveyer 21 of the loading and unloading means 20 and the gate 20g of the blocking wall 20w is closed. Thus, sterilization of a corpse surface can be performed using the sterilizing means of the loading and unloading means 20. Note that the gate 30g of the blocking wall 30w is closed during sterilization.

When sterilization is complete, the gate 30g of the blocking wall 30w is opened. Then, the conveyer 21 of the loading and unloading means 20 operates, and the corpse and the tray T are transported and then supplied to the corpse heating means 30 through the opening h of the blocking wall 30w. The conveyer 31 of the corpse heating means 30 also operates at this time and the tray T is moved smoothly to the conveyer 31.

When the tray T is moved to the conveyer 31, the gate 30g of the blocking wall 30w closes, the corpse is heated using the heating unit 32 of the corpse heating means 30 and decay prevention processing of a corpse interior is performed by heating.

When the decay prevention processing is complete, the gate 30g of the blocking wall 30w opens. Then, the conveyer 31 of the corpse heating means 30 operates, and the corpse and the tray T are transported and then supplied to the loading and unloading means 20 through the opening h of the blocking wall 30w. The conveyer 21 of the loading and unloading means 20 also operates at this time and the tray T is moved smoothly to the conveyer 21.

When the tray T is moved to the conveyer 21, the gate 30g of the blocking wall 30w closes and the corpse is cooled using the corpse cooling means of the loading and unloading means 20.

When cooling is complete, the gate 20g of the blocking wall 20w opens and the conveyer 21 operates. Then, the corpse and the tray T are transported to the outside through the opening 1s and the opening h of the blocking wall 20w and the processing of the corpse completes.

According to the corpse processing vehicle 1 of the present embodiment, if the corpse is loaded and unloaded to the loading and unloading means 20 through the opening 1s as described above, the corpse can be moved between the loading and unloading means 20 and the corpse heating means 30.

Then, sterilization can be performed by the sterilizing means and cooling can be performed by the corpse cooling means in the loading and unloading means 20 and electromagnetic heating of the corpse can be performed using the corpse heating unit 32 in the corpse heating means 30. Thus, since the various processes are able to prevent the decay of the corpse, damage to the corpse can be slowed.

And, since equipment 10 is mounted in the cargo compartment 1h of the corpse processing vehicle 1, the corpse processing vehicle 1 can be moved to the scene where the corpse is and can thus process the corpse. Accordingly, since processing can be done quickly before the corpse is damaged; it is possible to turn a relatively undamaged corpse over to a surviving family member and the like. Furthermore, since the corpse is simply processed through the various means, no special technique is required and thus, as long as the corpse processing vehicle 1 is moved to the scene where the corpse is, anyone can treat the corpse.

Furthermore, if the operation of the conveyer 21 of the loading and unloading means 20 and the operation of the conveyer 31 of the corpse heating means 30 and the opening and closing of the gates 20g and 30g of the blocking walls 20w and 30w and the like are controlled, the movement of the tray T on which the corpse is placed between the loading and unloading means 20 and the corpse heating means 30 can be automated. Then, if the processing of the corpse in the loading and unloading means 20 and the corpse heating means 30 is matched to the movement of the tray T (in other words, to the opening and closing of the conveyers and the gates) and performed automatically, the processing of the corpse can be automated.

Note that, as long as the tray T and the corpse can be transported, there is nothing in particular that limits the transporting means to that of conveyers.

Next, the various processing means will be described in detail. The corpse heating means 30 will be described first. As illustrated in FIG. 1 and FIG. 2, the corpse heating means 30 includes the conveyer 31. The conveyer 31 includes a pair of endless belts and the gap therebetween is arranged so as to be narrower than the width of the tray T.

As illustrated in FIG. 1, an electrode part 33 of the heating unit 32 is provided between the pair of endless belts on the conveyer 31. The electrode part 33 has an electrode plate 33a and a lifting and lowering unit 33b that moves the electrode plate 33a up and down. The lifting and lowering unit 33b is, for example, the cylinder and the like arranged such that the axial direction thereof is facing in a vertical direction in FIG. 1, but is not particularly limited thereto as long as the electrode plate 33a can be moved up and down thereby.

On the other hand, as illustrated in FIG. 1, an electrode 34 of the heating unit 32 is provided above the electrode part 33 and above the conveyer 31. The electrode 34 has an electrode 34a and electrode moving means 34b that moves the electrode 34a up and down. The electrode moving means 34b can be configured of, for example, a supporting member that supports the electrode 34a and the cylinder that moves the supporting member up and down and the like, but is not particularly limited thereto as long as the electrode 34a can be moved up and down thereby.

Furthermore, the electrode 34a of the electrode 34 and the electrode plate 33a of the electrode part 33 are connected to a high-frequency device not illustrated in the figure that is able to generate high-frequency electric power.

Since this is the structure, the tray T on which the corpse is placed is arranged on the conveyer 21 and a through hole Th of the tray T is arranged above the electrode part 33 and when the electrode 34a of the electrode 34 and the electrode plate 33a of the electrode part 33 are brought close by the lifting and lowering unit 33b and the electrode moving means 34b in this state, the corpse can be sandwiched between the two.

When high-frequency electric power generated by the high-frequency device is applied between the two electrodes in this state, electromagnetic waves of high-frequency (between 1 MHz and 100 MHz) can be applied to the tissue of the corpse. Thus, since the tissue of the corpse is electromagnetically heated through the electromagnetic waves and the tissue of the corpse self-heats, the temperature of viscera and the like of the tissue of the corpse interior can be raised. For example, if the tissue of the corpse interior is electromagnetically heated by the application of electromagnetic waves of 13.56 MHz with an output of between 1000 and 2000 W for 30 minutes or more, the temperature thereof can reach 60 degrees or more. Furthermore, if that state is held for 5 minutes or more, and optimally for between 5 and 20 minutes, in other words, if the temperature of the corpse interior is held at 60 C.° or more for between 5 and 20 minutes, proteins that configure the tissue of the corpse interior can be solidified. Furthermore, since the tissue of the corpse interior has been heated at a temperature of 60 degrees for between 5 and 20 minutes, which is a high temperature when compared to an in vivo temperature, bacteria attached to the tissue of the corpse interior can be killed and reduced. Thus, the growth rate of bacteria attached to the tissue can be suppressed even if electromagnetic heating is stopped and the temperature of the corpse interior decreases and the rate of decay of the tissue of the corpse interior can be slowed.

The temperature of parts other than the tissue of the corpse interior, in other words, the tissue of the corpse surface, also rises at this time, but the surface of the corpse is in contact with the open air (the air inside the cargo compartment 1h) and both electrodes and thus has been cooled by the open air and the like. Therefore, the temperature of the corpse surface can be made cooler than the corpse interior and just the proteins that configure the tissue of the corpse interior can be solidified while preventing the proteins that configure the tissue of the corpse surface from solidifying or, put another way, while preventing the corpse surface from becoming damaged through being discolored or burnt. In particular, by electromagnetically heating with high-frequency electromagnetic waves with a frequency of between 1 and 100 MHz and an output of between 1000 and 2000 W for approximately 30 to 60 minutes, the corpse surface can more reliably be prevented from becoming damaged through being discolored or burnt.

In particular, by providing a well-known pad that can pass circulating cooling water in the portion of the electrode 34a of the electrode 34 that makes contact with the corpse surface, the corpse surface can be prevented from discoloring. For example, the pad is configured by forming a material having water resistance such as a urethane sheet and the like into a bag shape and then supplying a liquid that has conductivity like salt water of between approximately 1 and 3% and the like as circulating cooling water therein. Thus, since the corpse surface can be cooled using the pad when electromagnetic waves are being applied using the electrode 34a of the electrode 34, the temperature of the corpse surface can be prevented from rising even if the electromagnetic waves are applied to the corpse for a long period of time, damage to the corpse surface can reliably be prevented. Furthermore, since electromagnetic waves can be applied to the corpse for longer or the output thereof made stronger, heating to deep inside the corpse can reliably be achieved. In particular, since the pad like that described above is just circulating cooling water inside a bag and is very flexible, the electrode 34a can be made to adhere to the corpse better than in a case where the electrode 34a is configured from just a simple conductive plate and the like. Thus, since uniform electromagnetic waves can be applied to the entire abdomen of the corpse, temperatures of localized portions of the corpse can be prevented from rising abnormally.

Note that the pad may be provided separately from the electrode 34a. If, in this case as well, the pad is configured by forming a material having water resistance such as a urethane sheet and the like into a bag shape and then supplying a liquid that has conductivity like salt water of between approximately 1 and 3% and the like as circulating cooling water therein as was the bag provided in the electrode 34a, then the same effect can be achieved. Furthermore, when the pad is provided separately from the electrode 34a, the size of the pad can be determined freely without regard to the size of the electrode 34a. For example, the pad can be big enough so as to be able to cover the abdomen and can also be made big enough so as to be able to cover the entire corpse. Furthermore, when the pad is provided, the corpse surface is cooled in and electromagnetic waves can be applied to the portions thereof where the pad is provided and thus electromagnetic waves can be supplied to an area that is larger than the electrode 34a and the electromagnetic waves applied to the corpse at the portions where the pad is provided can be made nearly uniform.

Furthermore, the pad may be arranged on the upper surface of the corpse only, but is preferably arranged so as to enclose the corpse. If the pad is arranged so as to enclose the corpse, variations in the electromagnetic waves applied to the corpse can be suppressed in the portions that are enclosed. For example, if an electrode having the same structure as electrode 34a is provided instead of the electrode plate 33a of the electrode part 33, it becomes possible to enclose the corpse with the pad.

Note further that the method for cooling the surface of the corpse during heating is not limited to the method of providing a pad like that described above and methods such as a method that cools by blowing cold air of about 5 C.° on the abdomen of the corpse or a method that provides a cooling water passage through which cooling water can flow inside the electrode and thus improves a corpse cooling effect using the electrode, and the like may also be used.

Note further that if the corpse surface can be cooled adequately using just the electrode 34a or the open air, means for cooling the corpse surface such as the pad and the like need not be provided.

Furthermore, when the corpse is enclosed by the electrode 34a and the electrode plate 33a, in other words, when the corpse is electromagnetically heated using electromagnetic waves of between 1 MHz and 100 MHz, both the electrode 34a and the electrode plate 33a must be brought into direct contact with the corpse. Therefore, a tray including the through hole Th which can pass the electrode plate 33a that is below the portion where the abdomen of the corpse is positioned is used as the tray T on which the corpse is placed. However, if just the central part of the tray T, in other words, the portion where the abdomen of the corpse is placed, is a conductive material while the rest of the tray T is formed of an insulator, then the tray T itself can be used as the electrode. In this case, if the portion of the tray T formed of conductive material and the high-frequency device are configured so as to be connected when the tray T is arranged in a predetermined position, electromagnetic waves will be generated between the tray T and the electrode 34a above. Furthermore, since only the portion where the abdomen of the corpse is positioned is of conductive material, electromagnetic waves can be prevented from being supplied to portions other than the abdomen of the corpse and thus the abdomen alone can be effectively heated. Furthermore, since the lifting and lowering unit 33b that moves the electrode plate 33a need not be provided, the structure of the corpse heating means 30 can be simplified and thus the entire structure of the equipment can be simplified and made compact.

Note that a unit that electromagnetically heats the corpse using microwaves of between 300 and 3000 MHz (for example, 915 MHz microwaves and the like) may be used as the heating unit 32. In this case, an applicator that can irradiate microwaves in a predetermined direction can be provided instead of the electrodes. Thus, since there is no need to adhere the applicator to the corpse, there is no need for moving means for moving the applicator and the structure of the corpse heating means 30 can be simplified.

Since, as described above, the corpse heating means 30 can enclose the corpse using the electrodes 34 and 33 and apply electromagnetic waves and can electromagnetically heat the corpse simply by irradiating the corpse with microwaves using the applicator; in other words, can perform decay prevention processing of the corpse interior, a special technique is not necessary and thus anyone can process the corpse.

Furthermore, the corpse heating means 30 may provide a hood that covers the electrode 34 and the corpse at the time of heating. If the hood is formed of material that shields against electromagnetic waves in this case, the electromagnetic waves can more reliably be prevented from leaking to the outside. Note that the structure of the hood is not particularly limited and a well-known hood that opens and closes can be used.

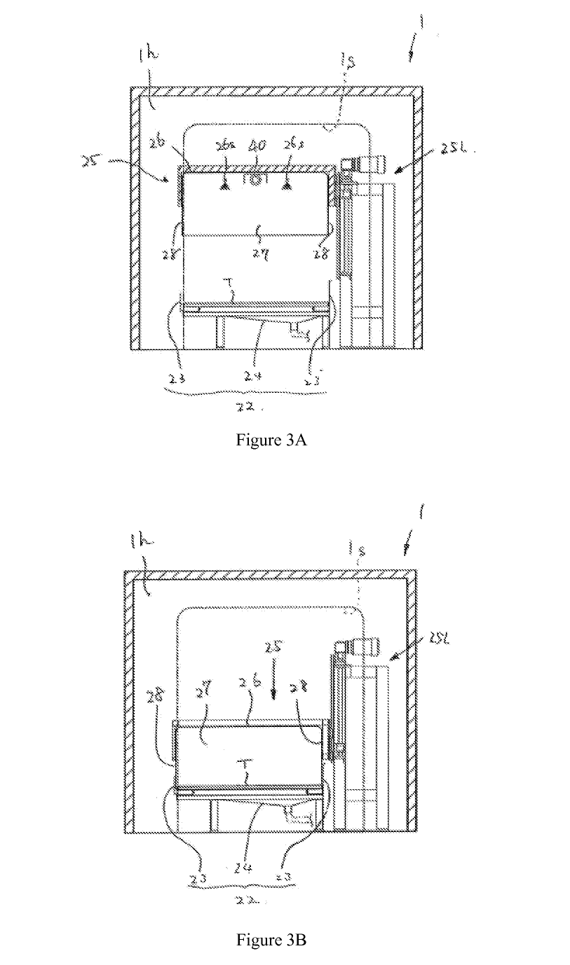

Next, the loading and unloading means 20 will be described. As illustrated in FIG. 1 and FIG. 3, the loading and unloading means 20 has a case 22 with an opening upward and a lid section 25 that is arranged above the case 22 and provided so as to be able to move toward and away from the opening of the case 22 in a vertical direction.

As illustrated in FIG. 2 and FIG. 3, the case 22 has an opening upward and a hollow space inside. Specifically, the case 22 has a bottom panel 24 and a pair of side walls 23 and 23 erected at the side edges of the bottom panel 24.

The conveyer 21 that transports the tray T is provided inside the case, in other words, on the upper surface of the bottom panel 24. The conveyer 21 is provided so that the direction in which the tray T is transported is parallel to the axial direction of the case 22 (horizontal direction in FIG. 1 and FIG. 2).

Furthermore, the case 22 has a bottom panel 24 and a pair of walls 23 and 23, but is not provided with walls at either end in an axial direction. In other words, the case 22 is open at both ends in the axial direction and is formed in the shape of a gutter with a substantially U-shaped cross section.

Since the case 22 has this form, the walls of the case 22 do not become a hindrance at the time the tray T on which a corpse has been placed is loaded in the loading and unloading means 20. Accordingly, work such as placing the tray T on the conveyer 21 inside the case 22 and then retrieving the tray T from the conveyer 21 inside the case 22 can be performed easily.

Note that a drain 24h and an incline facing the drain 24 are formed in the bottom panel 24 of the case 22 and the reason for this is described below.

As illustrated in FIG. 1 and FIG. 3, the lid section 25 is provided above the case 22. The lid section 25 is provided so as to be able to move toward and away from the case 22 in a vertical direction. Specifically, the lid section 25 is attached to a lifting and lowering device 25L and is provided so as to move up and down when the lifting and lowering device 25L is operated. The structure of the lifting and lowering device 25L is not particularly limited as long as the lid section 25 can be moved up and down thereby. For example, a structure that has a lifting and lowering frame that fixes the lid section 25 and that moves the lifting and lowering frame up and down using a screw mechanism or a cylinder mechanism can be used.

As illustrated in FIG. 1 and FIG. 2, the lid section 25 has an opening downward and is formed in a box shape having a hollow space inside. Specifically, the lid section 25 has a top panel 26, a pair of blocking plates 27 and 27 provided on the front and rear edge and a pair of side walls 28 and 28 provided on the side edges of top panel 26. Note that adjoining blocking plates 27 and side walls 28 are connected together by the side edges thereof.

The width of the lid section 25, in other words, the distance between the outer surfaces of the pair of side walls 28 and 28, is narrower than the distance between the inner surfaces of the pair of side walls 23 and 23 on the case 22.

Furthermore, the pair of blocking plates 27 and 27 on the lid section 25 are provided such that the length between the inner surfaces thereof is shorter than the length of the case 22, but longer than the conveyer 21 that is provided inside the case 22.

Furthermore, the lid section 25 is formed such that, when being lowered by the lifting and lowering device 25L, the pair of blocking plates 27 and 27 and the pair of side walls 28 and 28 go inside the case 22.

Specifically, the lid section 25 is formed so that front edges of the pair of side walls 28 and 28 go inside of the pair of side walls 23 and 23 on the case 22 when the lid section 25 is lowered and thus go into a gap between the pair of side walls 23 and 23 and the conveyer 21 (refer to FIG. 3 (B)). Put another way, the pair of side walls 28 and 28 are formed such that the front edges thereof are positioned below the sides of the tray T when the tray T is placed on the conveyer 21 when the lid section 25 is lowered.

Furthermore, the pair of blocking plates 27 and 27 are formed such that the front edges thereof are arranged in the position of the conveyer 21 in the case 22 when the lid section 25 is lowered. Put another way, the pair of blocking plates 27 and 27 are formed so that the front edges thereof are positioned below the sides of the tray T when the tray T is placed on the conveyer 21 when the lid section 25 is lowered (refer to FIG. 3 (B)).

In other words, the lid section 25 is formed such that when the lid section 25 is lowered using the lifting and lowering device 25L, the corpse placed on the tray T on the conveyer 21 can be enclosed by the pair of blocking plates 27 and 27 and the pair of side walls 28 and 28. Put another way, the lid section 25 is formed such that the corpse placed on the tray T can be housed in a space formed by the tray T and the lid section 25 in a nearly airtight state.

Accordingly, since the loading and unloading means 20 is not provided with walls at either end in the axial direction, work such as placing the tray T on the conveyer 21 inside the case 22 and then retrieving the tray T from the conveyer 21 inside the case 22 can be performed easily if the lid section 25 is raised. On the other hand, if the lid is lowered, the corpse can be housed in a nearly airtight state in the space formed by the lid section 25 and the tray T even though the case 22 is not provided with walls at either end in the axial direction. Note that while a nearly airtight space does not mean one completely sealed off from the outside it does mean a space where the flow of gas and liquid between the outside and the space is limited to a certain degree.

Next, the sterilizing means will be described. As illustrated in FIG. 3A, the loading and unloading means 20 has ultraviolet irradiating means 40 that is the sterilizing means. The ultraviolet irradiating means 40 is attached to the top panel 26 of the lid section 25. Therefore, if the lid section 25 is lowered and the ultraviolet irradiating means 40 is lit with the corpse in a nearly airtight state in the space formed by the lid section 25 and the tray T, the surface of the corpse can be sterilized using the ultraviolet rays irradiated from the ultraviolet irradiating means 40. Therefore, damage through the decay and the like of the corpse surface can be slowed and a worker and the like that comes in contact with the corpse can be prevented from being infected by bacteria and the like. Furthermore, if the oxygen inside the space is converted to ozone using the ultraviolet rays irradiated from the ultraviolet irradiating means 40, it is possible to sterilize the corpse using the ozone. Furthermore, since the ultraviolet rays are irradiated inside the space formed by the lid section 25 and the tray T, the ultraviolet rays do not leak to the outside. Accordingly, the worker and the like can be prevented from being exposed to the ultraviolet rays.

It is not only acceptable that the sterilizing means converts the oxygen inside the space to ozone using the ultraviolet rays, but may also supply ozone directly into the space and sterilize the corpse using the ozone. If ozone penetrates to the corpse interior through the mouth and the like in this case, it is possible to sterilize the corpse interior with the ozone. Furthermore, if the ozone penetrates the tissue and the like of the corpse through a nostril and the like, bacteria can be prevented from re-attaching to the corpse surface and damage through the decay and the like of the corpse surface can be slowed.

Note that the method for supplying ozone into the space is not especially limited and, for example, an ozone generating device may be mounted on the vehicle and the ozone generated by the ozone generating device may be supplied to a nozzle 26s using a pipe and the like.

Furthermore, when ozone is supplied into the space, a state where nebulized water droplets exist together with the ozone is preferred. If this state is realized, water droplets will attach to the corpse surface along with the ozone. The ozone and the water droplets react with one another and thus reach an ozone water state and an ozone water film is formed on the corpse surface by the ozone water. When the ozone water film is formed, a sterilizing effect of the corpse surface is increased and thus bacteria and the like can be prevented from attaching to the corpse surface for a relatively long period of time (for example, between several days and approximately one or two weeks). Thus, since damage to the corpse surface by bacteria and the like can be prevented for a relatively long period of time, damage to the outer appearance of the corpse can be prevented for a relatively long period of time.

Note that the method for reaching the state where the ozone and nebulized water droplets exist is not particularly limited. For example, in a state where ozone is being supplied into the space through the nozzle 26s, by spraying water into the space through another nozzle 26s so that nebulized water droplets are formed, a state where ozone and nebulized water exist can be achieved. Conversely, the ozone may be supplied into the space using the nozzle 26s after the nebulized water droplets have been formed by spraying water into the space through the nozzle 26s. Of course, water may be sprayed into the space to form the nebulized water droplets simultaneous to the ozone being supplied into the space.

Note further that the material used for sterilization is not particularly limited in that any material having sterilizing action such as alcohol, ozone water, chlorine dioxide water, sodium hypochlorite water and the like is acceptable, and is thus not limited to ozone.

Processing the ozone, water and the like supplied into the space becomes a problem here, but since the drain 24h is formed in the bottom panel 24 of the case 22 and the incline is formed toward the drain 24h, liquid used in sterilization can be gathered and recovered in the drain 24h. Thus, a further advantage is achieved in that since the recovered liquid can be reused, the amount of liquid included in the vehicle 1 can be reduced. Furthermore, an exhaust port is provided in the lid section 25 and sucking the gas from inside the space using a vacuum pump and the like makes it possible to prevent gases inside the space such as ozone and the like from leaking to the outside.

The corpse heated by the corpse heating means 30 is cooled using the corpse cooling means of the loading and unloading means 20, but the method for cooling the corpse is not particularly limited. Cooling may be done by a method optimal for the season and environment of the corpse processing.

For example, the corpse can be cooled by supplying a refrigerant, for example, a liquid used for cooling such as alcohol or liquid nitrogen or the like or a gas used for cooling such as nitrogen gas or Freon or the like, into the space through the nozzle 26s. By cooling the corpse for a predetermined period of time using this coolant, the temperature of the viscera can be cooled to, for example, 20 degrees or less and thus the amount of time the viscera is within the temperature range (approximately between 20 and 40 degrees) that facilitates growth of bacteria can be shortened. Therefore, even in cases where the entire tissue of the corpse interior is not completely solidified, the rate of decay of the unsolidified tissue can also be slowed. Furthermore, if the refrigerant also penetrates into the corpse interior through the mouth of the corpse and the like, the corpse interior can reliably be cooled.

In particular, the corpse can be cooled in a very short period of time when a very low temperature refrigerant such as liquid nitrogen or liquid carbon dioxide and the like is used. Thus, since the amount of time spent within the temperature range that facilitates growth of bacteria can be made extremely short, the rate of decay of the unsolidified tissue can also be slowed further.

Note that if a material having a sterilizing action such as alcohol and the like is used as the refrigerant, the corpse can be cooled and the corpse surface can be sterilized simultaneously by bringing the corpse into contact with the refrigerant.

Furthermore, when the refrigerant penetrates the corpse interior, the cooling of the corpse and the sterilization of the corpse interior can be performed simultaneously. Note that if alcohol is sprayed on the corpse when alcohol is used as the refrigerant, the corpse can be cooled by the vaporization heat of the alcohol.

Processing the refrigerant supplied into the space becomes a problem here, but just as in the aforementioned case of the sterilizing means, liquid can be recovered from the drain 24h, an exhaust port is provided in the lid section 25 and gas is sucked from inside the space using a vacuum pump and the like and thus the refrigerant can be recovered.

Furthermore, physiological saline solution supplying means for injecting a physiological saline solution into the interior of the corpse, for example; into the digestive tract of the corpse or into a cavity between the abdominal wall and the digestive tract of the corpse, before heating using the corpse heating means 30 may be provided in the corpse processing vehicle 1 of the present embodiment. When the physiological saline solution is injected, a cavity of a corpse interior can be filled to a certain degree with the physiological saline solution. Thus, when electromagnetic waves are applied using the corpse heating means 30; electromagnetic waves can be supplied evenly to the various parts of the corpse interior through the physiological saline solution. In other words, electromagnetic waves can be applied to a certain degree to regions where there is little application of electromagnetic waves when there is no physiological saline solution and, conversely, the application of electromagnetic waves can be weakened in regions where the application of electromagnetic waves is strong when there is no physiological saline solution. Thus, since a heated condition of the corpse interior is able to approach a uniform state when the corpse is heated using a heating unit of the corpse heating means 30, decay of and damage to the tissue of the corpse interior can be prevented for a relatively long period of time in comparison to a case where the heated condition of the corpse interior is not uniform.

Note that the method for injecting the physiological saline solution into the digestive tract of a corpse or into a cavity between the abdominal wall and the digestive tract of a corpse is not particularly limited. For example, anything having an injecting part formed using a hollow tubular member such as a perforation needle and the like, a physiological saline solution supplying part that can supply the physiological saline solution into the injecting part and injecting part moving means for thrusting the injecting part into the corpse may be the physiological saline solution supplying means. The injecting part can be thrust into the corpse and the tip thereof can be positioned in the digestive tract or in a cavity between the abdominal wall and the digestive tract of the corpse by the physiological saline solution supplying means. Thus, if the physiological saline solution is supplied into the injecting part using the physiological saline solution supplying part in that state, the physiological saline solution can be supplied through the inside of the injecting part into the location in which the tip is positioned. Note that when supplying the physiological saline solution into the digestive tract, it is possible to supply the physiological saline solution into the digestive tract by simply arranging a tube or the like in the mouth and supplying the physiological saline solution into the tube or the like.

Furthermore, the physiological saline solution supplying means may be provided in the loading and unloading means 20 or may be provided in the corpse heating means 30. However, the worker can spend less time in the space provided by the corpse heating means 30 when the physiological saline solution supplying means is provided in the loading and unloading means 20 and thus doing so is preferred.

Furthermore, interior sterilizing means for supplying a processing agent that includes a component having a sterilizing action in the interior of the corpse may be provided in the corpse processing vehicle 1 of the present embodiment. For example, if something having, for example, an injecting part formed using a hollow tubular member such as a perforation needle and the like, a processing agent supplying part that can supply the processing agent that includes a component having a sterilizing action such as, for example, alcohol, ozone water, chlorine dioxide water, sodium hypochlorite water and the like and injecting part moving means for thrusting the injecting part into the corpse is provided as the interior sterilizing means, the injecting part is thrust into the corpse, the tip thereof is positioned in the digestive tract or into a cavity between the abdominal wall and the digestive tract of the corpse and if the processing agent is then supplied to the injecting part using the processing agent supplying part, the processing agent can be supplied into the location in which the tip is positioned.

Thus, since residue in the digestive tract and internal organs in the abdominal cavity such as the digestive track and the like can be sterilized, the decay of the tissue of the corpse interior can be further slowed. Furthermore, since the processing agent is supplied by thrusting in the injecting part, the processing agent can also be supplied into a cavity between the abdominal wall and the digestive tract of the corpse that cannot be supplied from the mouth and the like and thus the sterilizing effect of the corpse interior can be further improved.

Note that the work to inject the processing agent using the interior sterilizing means may be performed at any time, but if the processing agent is injected after the corpse is heated, the growth of bacteria remaining in the corpse interior after heating can be suppressed. Note further that the configuration of the interior sterilizing means is not particularly limited and any configuration that can deliver the processing agent into the digestive tract or into a cavity between the abdominal wall and the digestive tract of the corpse is acceptable and is thus not limited to that described above.

Furthermore, the delivery of the processing agent into the interior of the corpse may be performed by hand and, in this case, the processing agent can reliably be delivered to the desired location regardless of the body type of the corpse.

Just as with the physiological saline solution supplying means, the interior sterilizing means may be provided in the loading and unloading means 20 or may be provided in the corpse heating means 30. However, the worker can spend less time in the space provided by the corpse heating means 30 when the interior sterilizing means is provided in the loading and unloading means 20 and thus doing so is preferred.

The following experiment was performed to verify the effectiveness of the corpse decay prevention method of the present invention. In the experiment, after a pig (of between 20 and 30 kg) was euthanized, the decay prevention method was performed on the pig and the viscera and outer appearance thereof were confirmed over the course of time.

The experiment performed the following comparative experiments (1) through (4).

### (1) Comparative Experiment 1

A case where sterilization using ozone and ultraviolet rays and electromagnetic heating (hereinafter referred to as the MC-06 process) was performed on a pig corpse that was left to stand at room temperature was compared to a case where a pig corpse was left to stand at room temperature as is.

### (2) Comparative Experiment 2

A case where the MC-06 process was performed on a pig corpse that was cooled with dry ice and left to stand at room temperature was compared to a case where a pig corpse was cooled with dry ice and left to stand at room temperature.

### (3) Comparative Experiment 3

A case where the MC-06 process was performed on a pig corpse that had been injected with a physiological saline solution that was then cooled with dry ice and left to stand at room temperature was compared to a case where the MC06 process was performed on a pig corpse that had not been injected with the physiological saline solution that was then cooled with dry ice and left to stand at room temperature.

Note that the MC-06 process was performed under the following conditions.

| | |
|---|---|
| High-frequency output and frequency | 1 to 3 kw, 13 to 56 MHz |
| Target temperature (abdominal cavity) and | 50 to 75° C., 10 to 15 min. |
| preservation time | |
| Ozone gas concentration and exposure time | 50 to 70 ppm, 3 min |

The fundamental conditions for electromagnetic heating when performing the MC-06 process on a human corpse are shown for reference purposes.

| | |
|---|---|
| Frequency of electromagnetic waves | 13 to 56 MHz |
| Electromagnetic wave output | 1 to 3 kw |
| Preservation time | 10 min. |
| Intra-abdominal temperature to be reached | Approximately 75° C. |

### Comparative Experiment 1

Groups of euthanized pigs (of between 20 and 30 kg); a group on which the MC-06 process was performed (MC-06 group: six pigs) and a group on which the MC-06 was not performed (comparison group: six pigs), were left to stand at room temperature, autopsies were performed and the degree of postmortem changes in both groups was compared macroscopically and histopathologically.

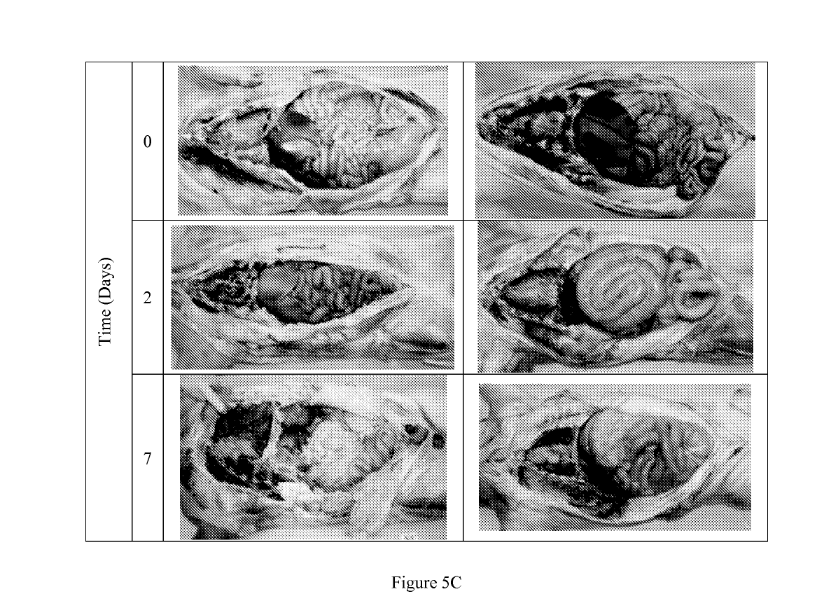

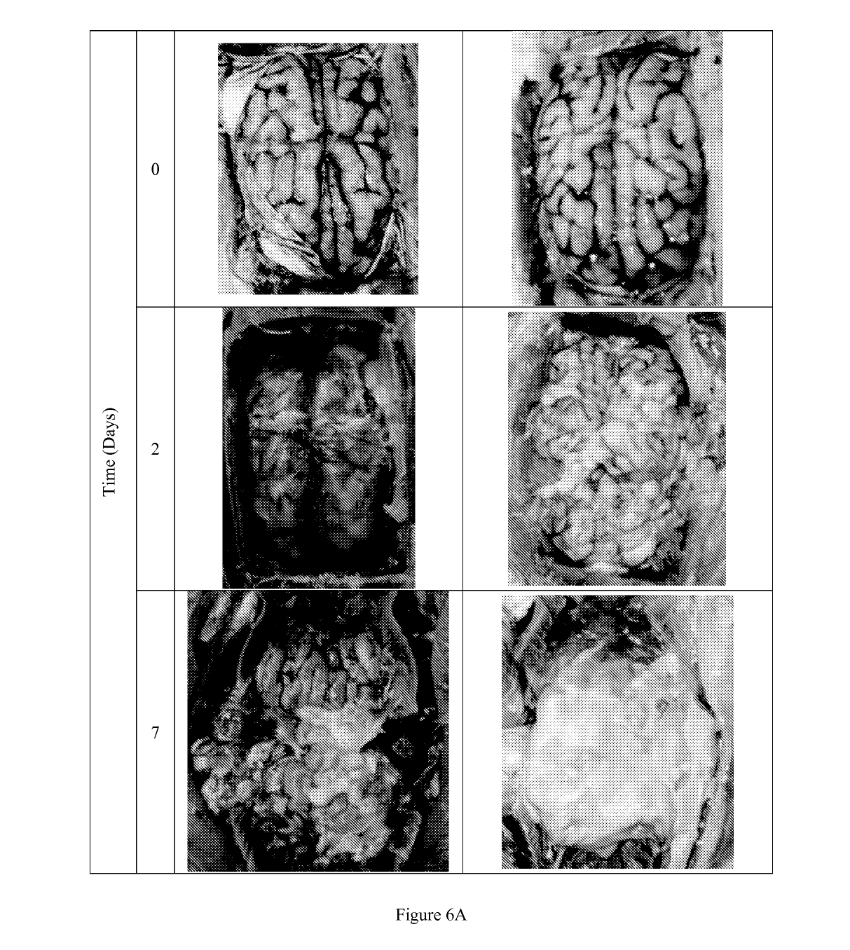

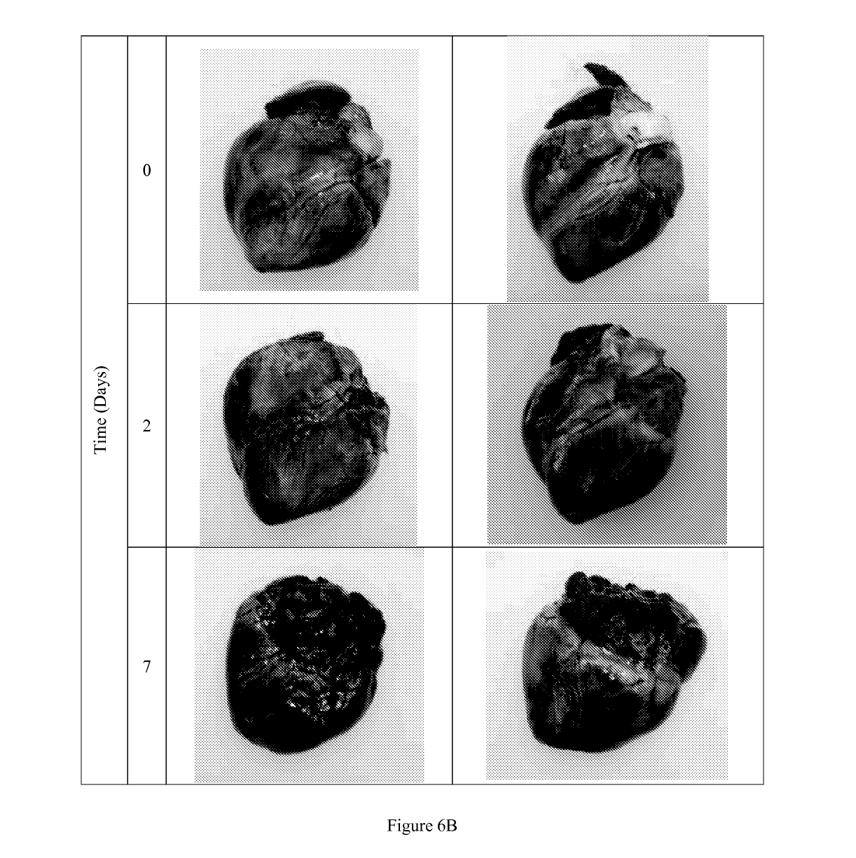

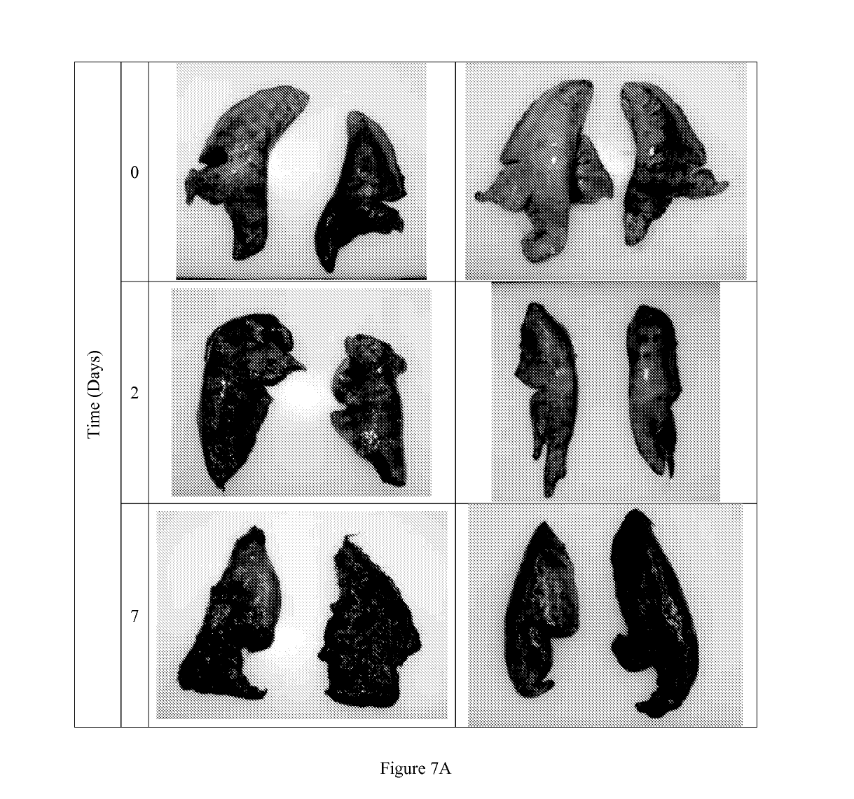

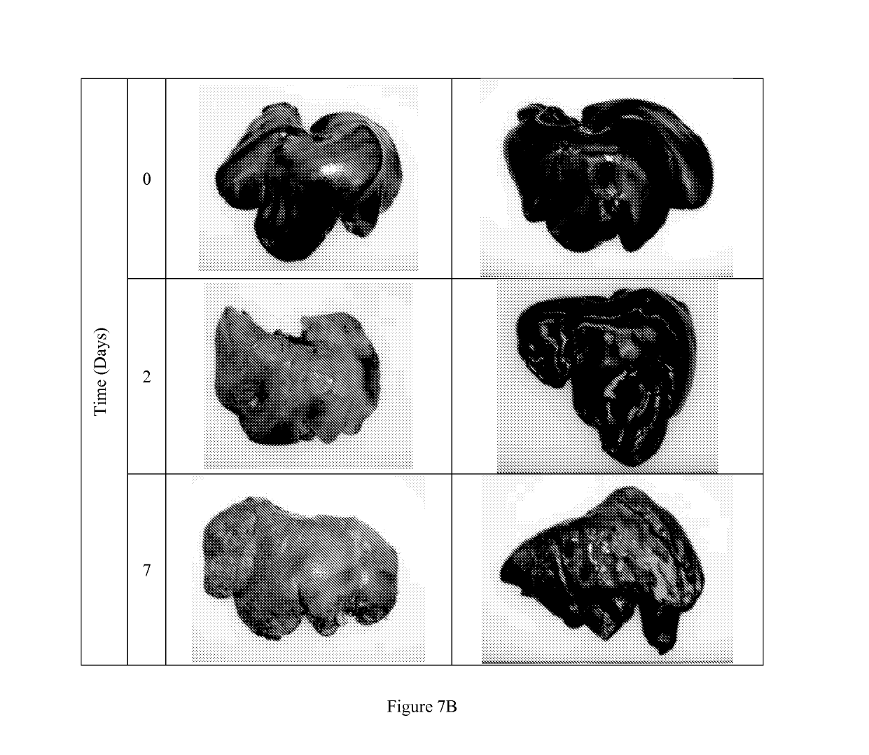

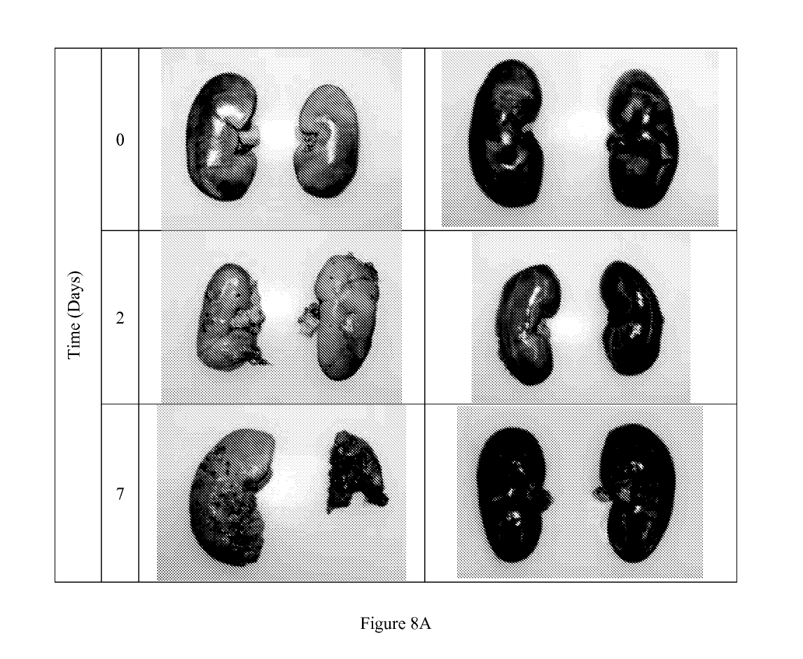

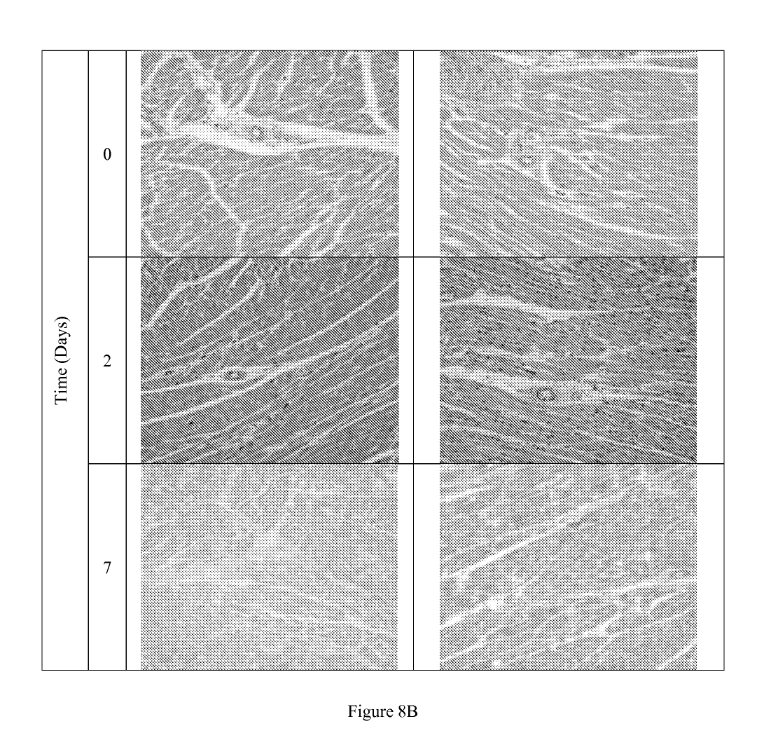

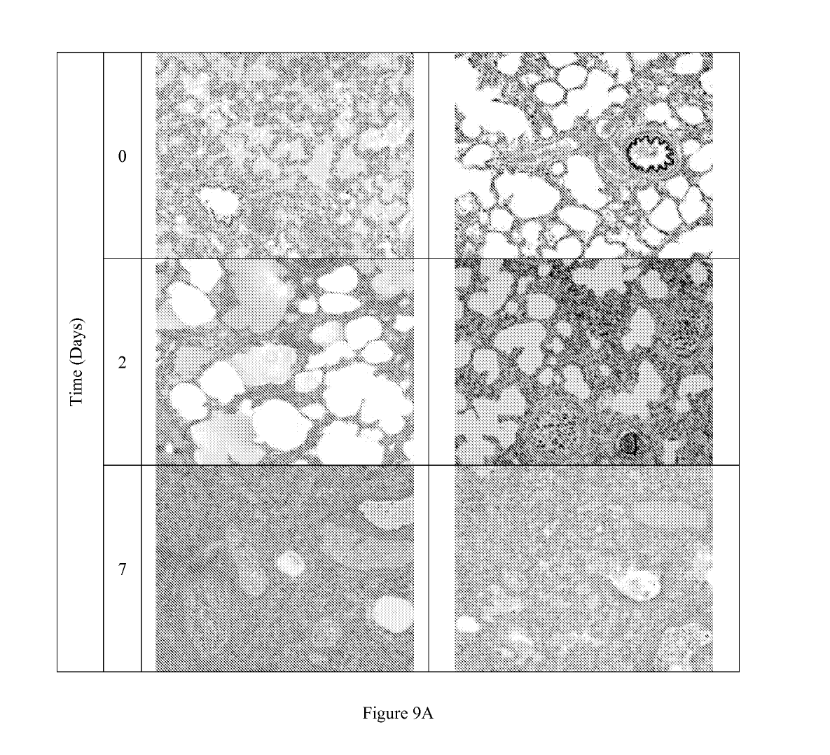

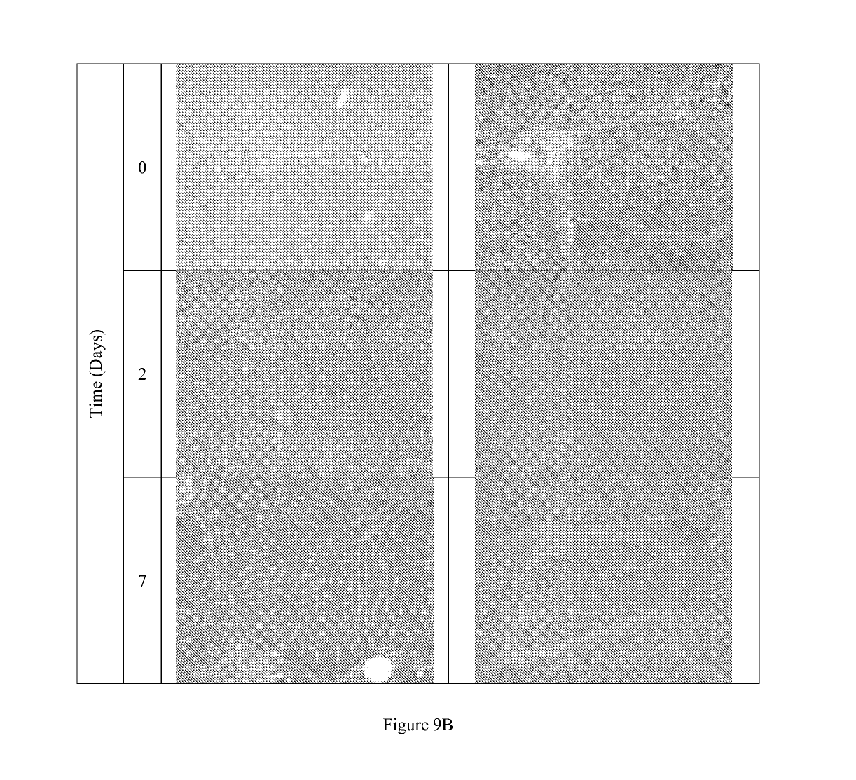

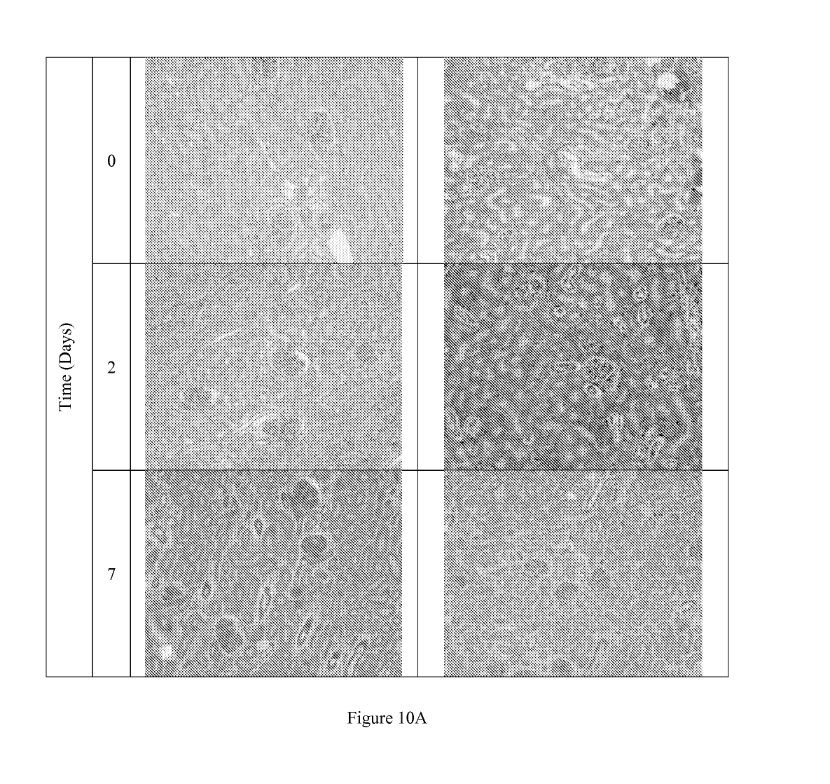

Results are illustrated in FIG. 5 through FIG. 10A. Postmortem changes through the course of time such as internal organ softening and blood infiltration and the like were observed in all of the internal organs and the degree thereof was strongly seen in the MC-06 process group. Note that changes caused by thermal denaturation, particularly in livers and kidneys, were also seen. Furthermore, postmortem changes such as nuclear atrophy and the shedding of epithelial cells and the like were observed in all of the internal organs, but the degree thereof was more strongly seen in the MC-06 process group.

Macroscopically, changes due to the application of heat were seen in the MC-06 group and, in particular, the livers were in a fixed state. The generation of intestinal gases was also suppressed. However, on the other hand, melting of the tissue caused by the application of heat was in progress.

Overall, general postmortem changes such as the occurrence of epidermolysis and decomposition mucus and the softening and melting of various internal organs other than the liver progressed more over the course of time in the MC-06 group than in the comparison group. Histopathologically, no significant differences were seen in either group.

Note that there were individuals in the MC-06 group where dark brown patches and fragility in the area of the skin that made contact with the electromagnetic wave generator occurred, intestinal tracts and diaphragms ruptured and the alveoli of the visceral pleura of the lungs were seen. This phenomenon was seen throughout all of the experiments. These changes are thought to have occurred because the electromagnetic wave output was somewhat too high for a pig (weighing between 20 and 30 kg).

### Comparative Experiment 2

The degree of postmortem changes in groups of pigs euthanized under the same conditions as in comparative experiment 1; a group on which the MC-06 process was performed and then the corpses of which were cooled with dry ice (20 kg of dry ice was used per pig and none was replaced and none was added) and then left to stand at room temperature as is (MC-06 cooled group: six pigs) and a group on which the MC-06 process was not performed and were cooled with dry ice and then left to stand as is at room temperature (cooled comparison group: 5 pigs), was compared macroscopically and histopathologically.

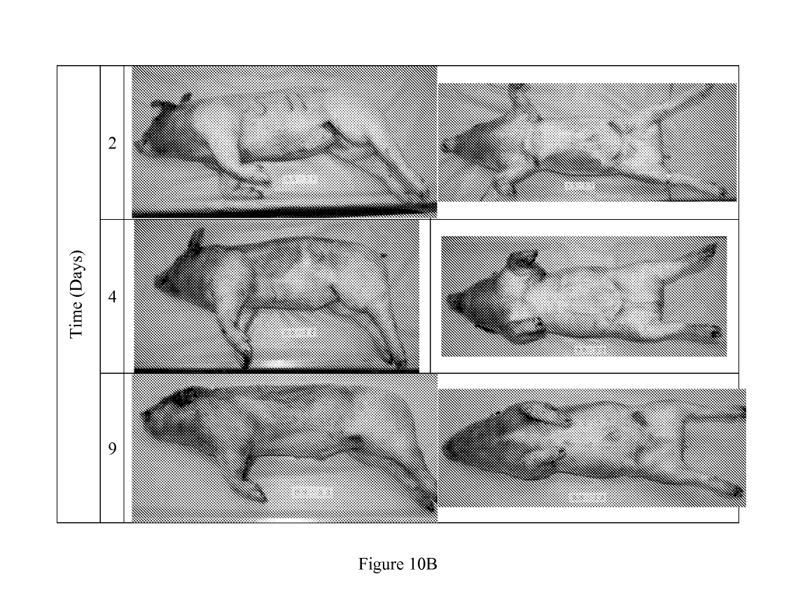

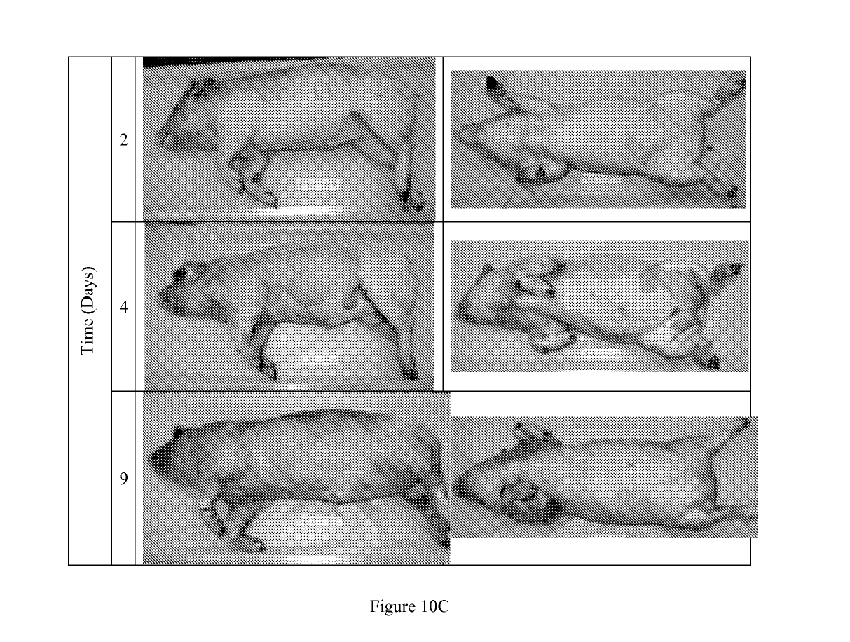

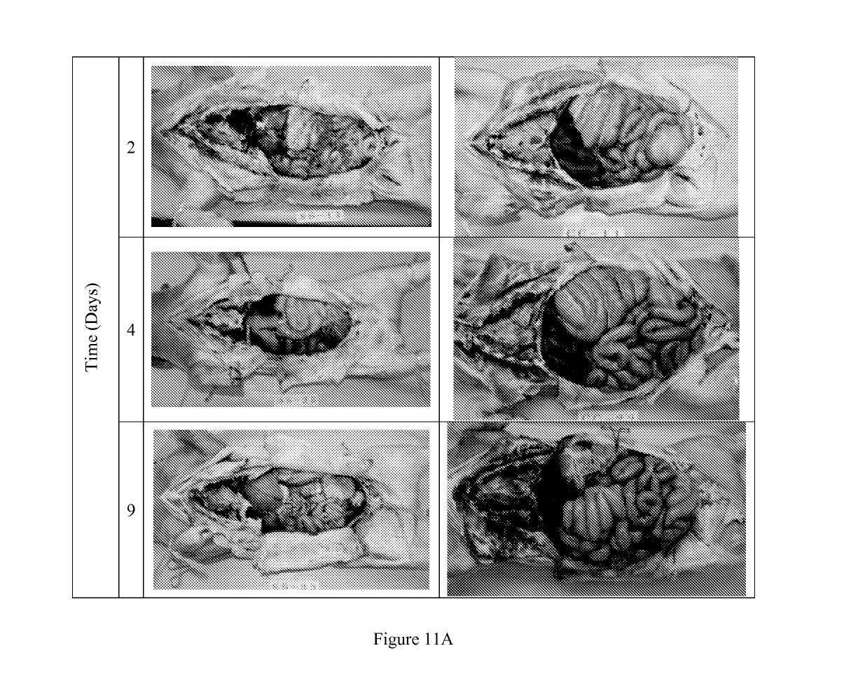

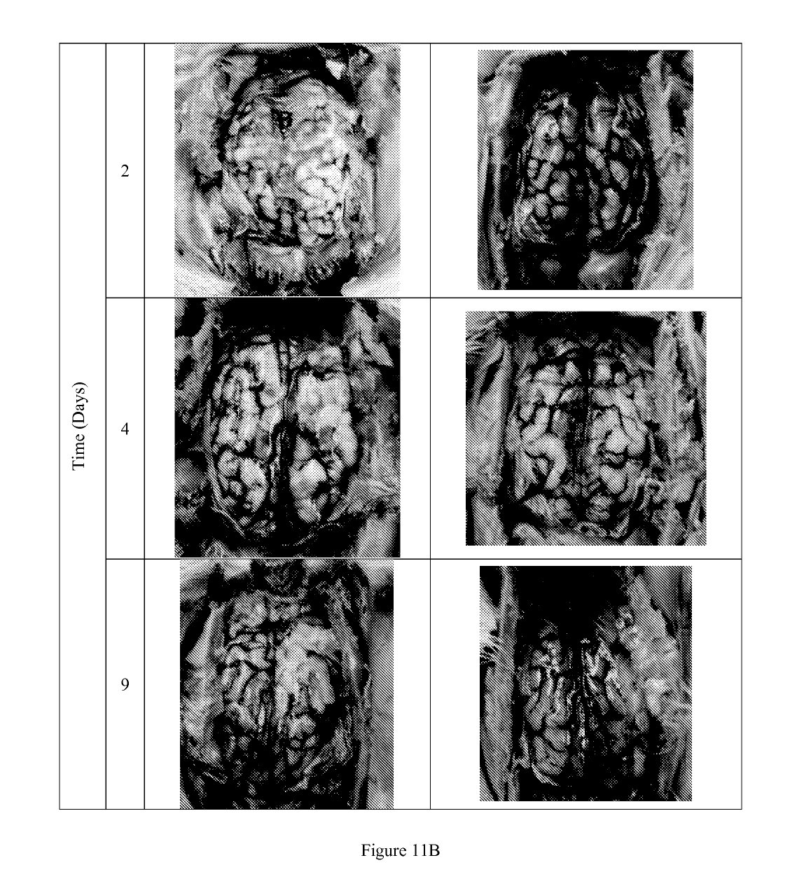

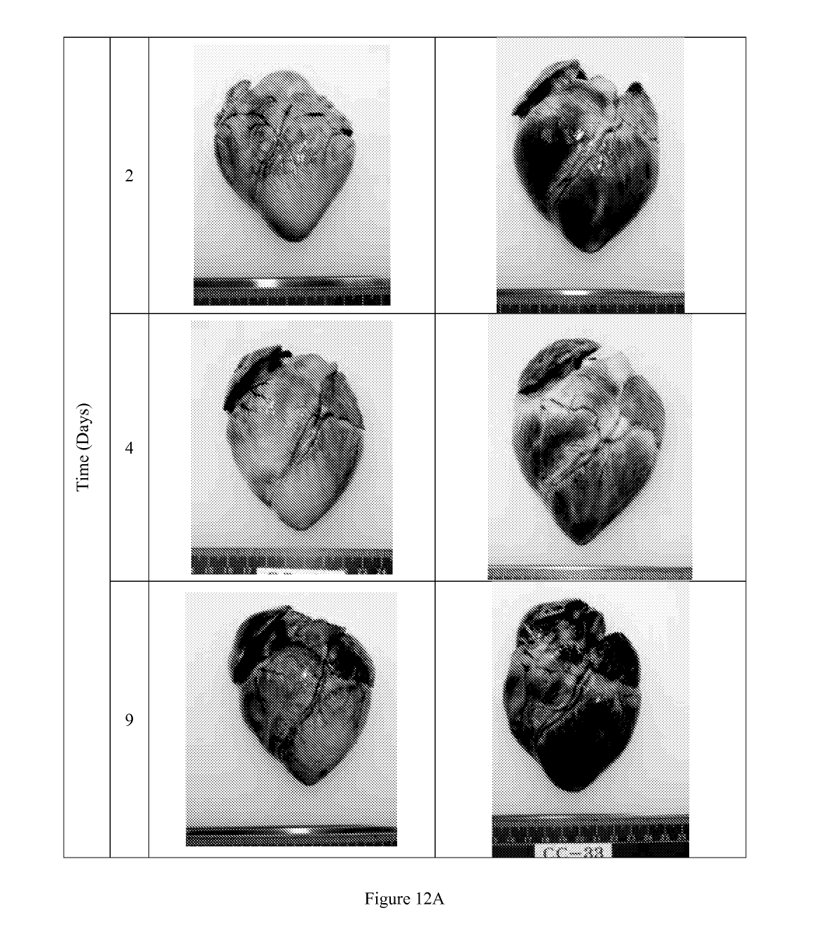

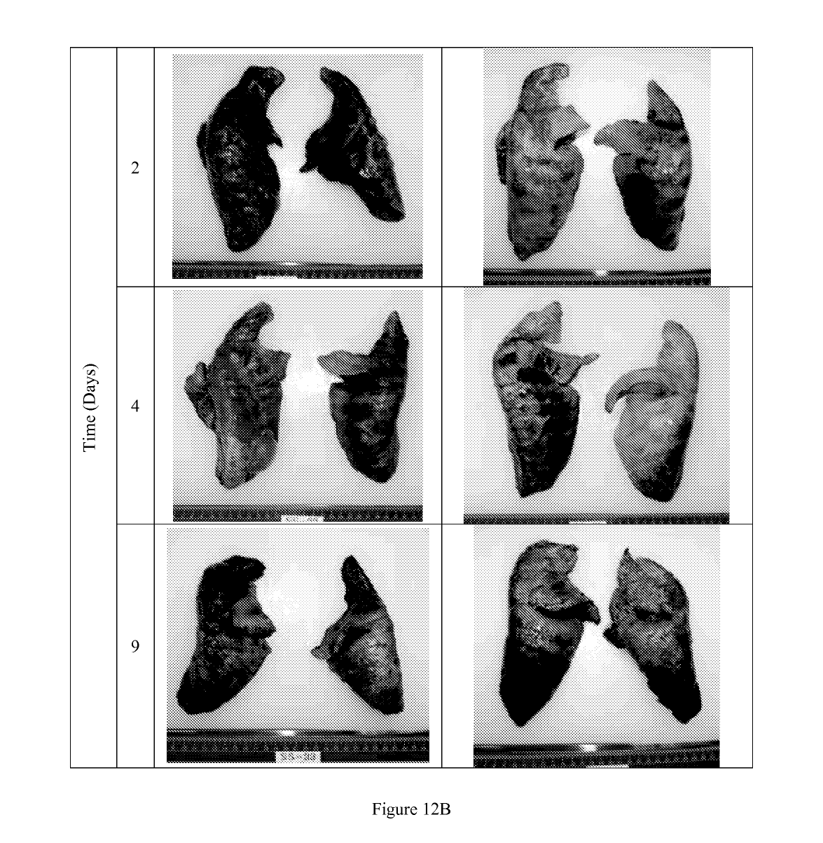

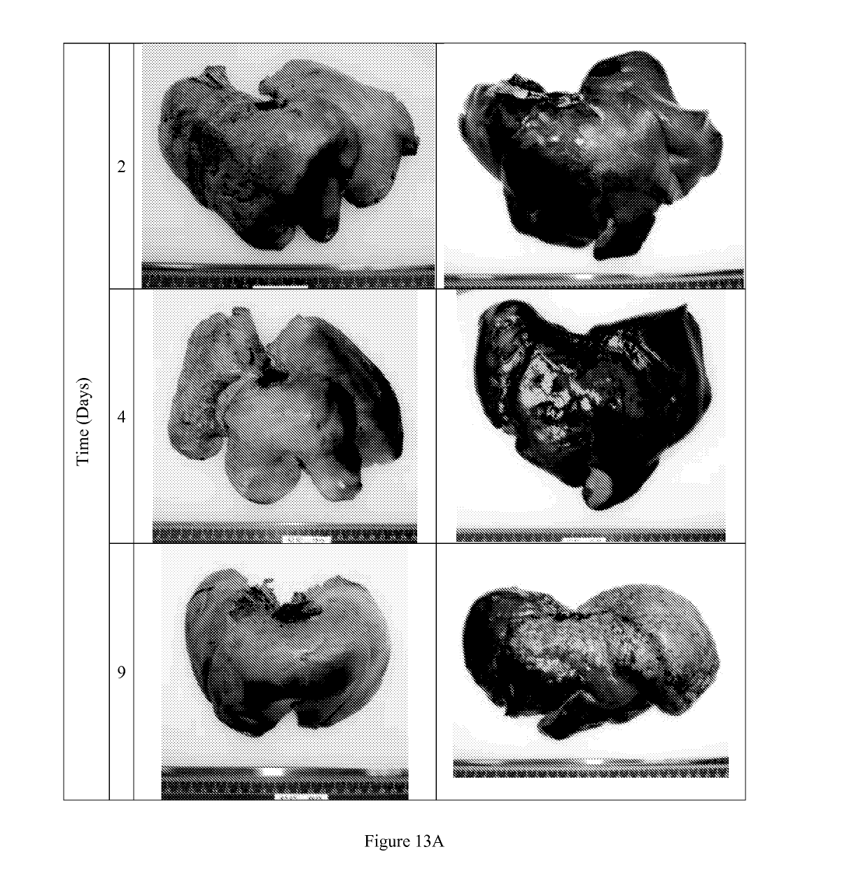

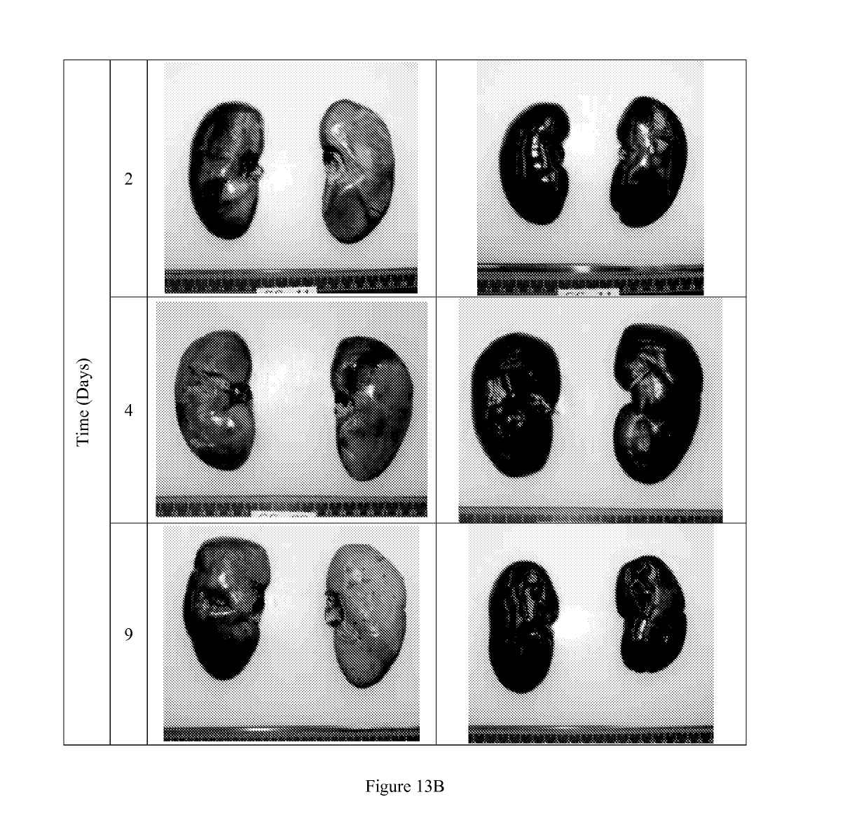

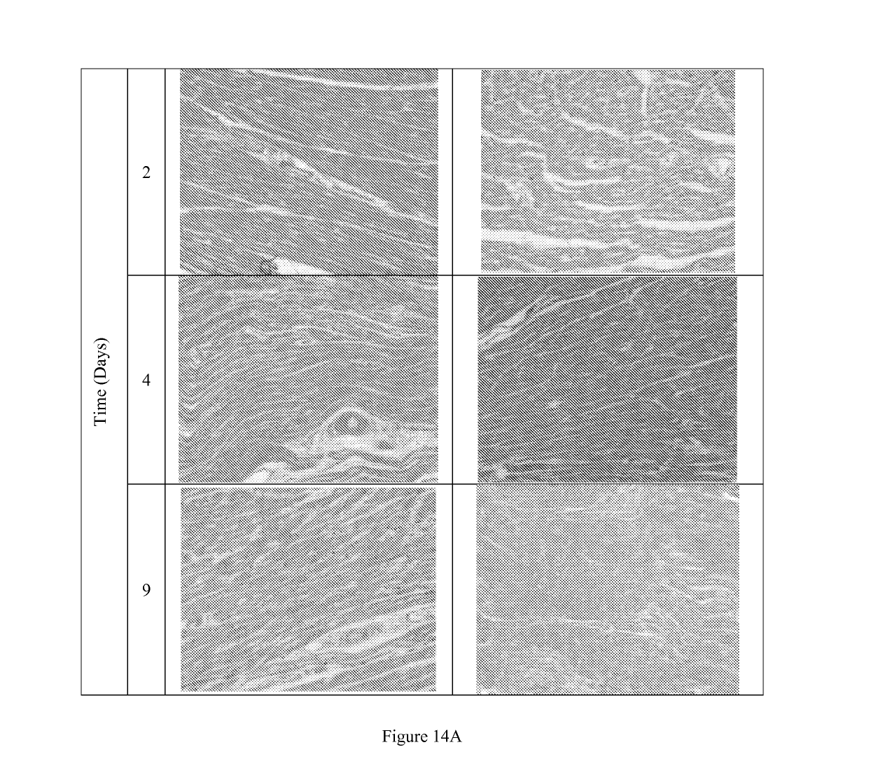

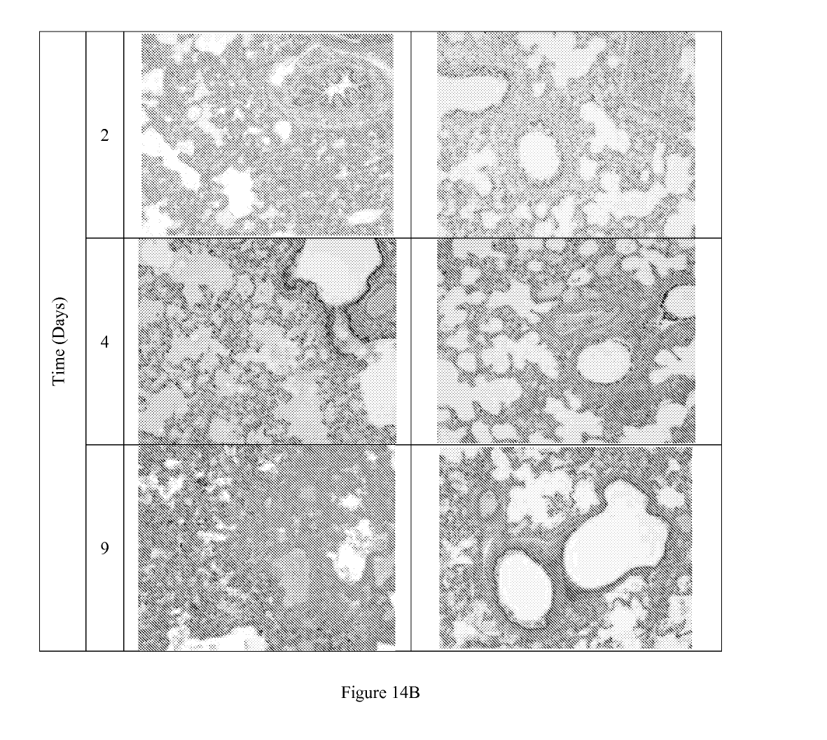

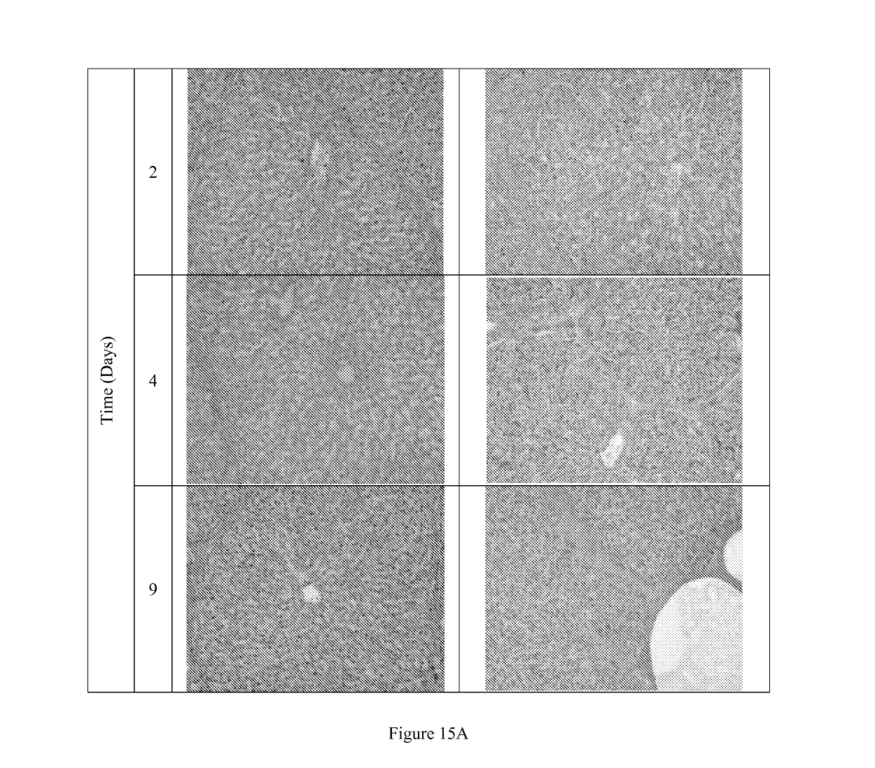

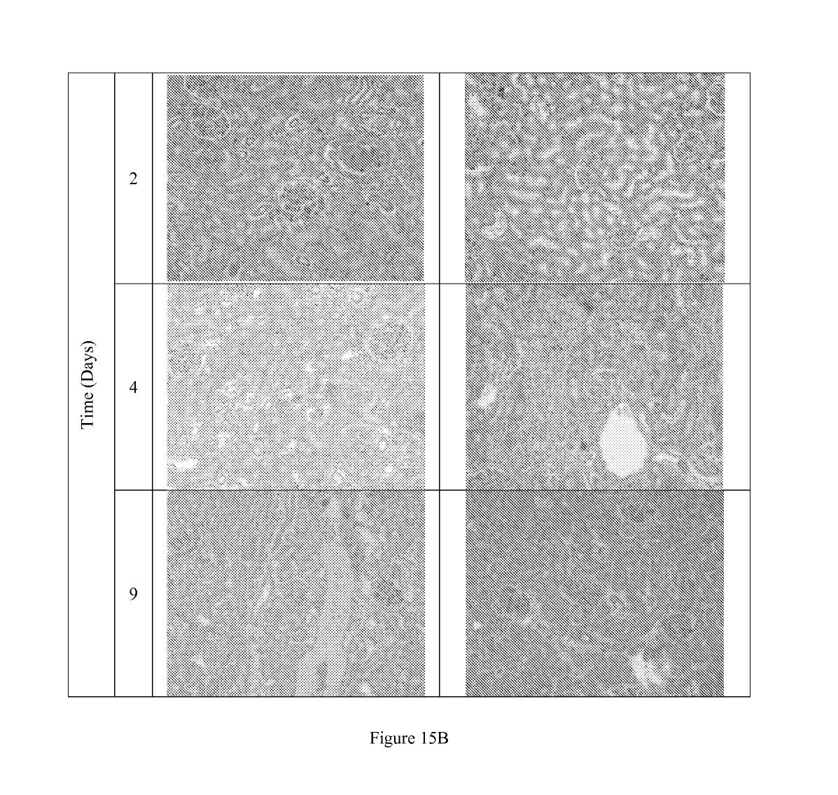

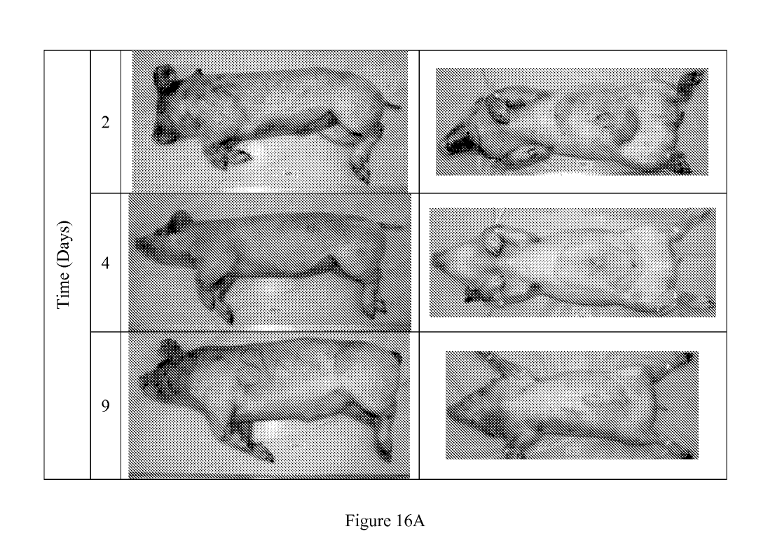

Results are illustrated in FIG. 10B through FIG. 15B. The progression of postmortem changes over the course of time was seen in all of the internal organs, but the state of preservation was better for the MC-06 cooled group.

Furthermore, while epidermolysis and tissue softening were seen beyond a week after death, the degree of postmortem changes in the MC-06 cooled group was kept relatively mild when compared to the cooled comparison group. It is thought that this is because histolysis caused by heat was suppressed by the cooling with the dry ice. Postmortem changes in the dry ice cooled group were suppressed histopathologicially as well.

Note that there were individuals in the MC-06 cooled group as well where skin discoloration and fragility, diaphragm and intestinal tract ruptures and alveoli of the visceral pleura of the lungs were seen, but it is thought that this is due to the same reason as described above.

### Comparative Experiment 3

The degree of postmortem changes in groups of pigs euthanized under the same conditions as in comparative experiment 1; a group on which the MC-06 process was performed after the abdominal cavities were injected with 1 liter of a 0.9% saline solution (the physiological saline solution) and then cooled with dry ice (no dry ice was replaced or added) and then left to stand at room temperature as is (saline injected group: three pigs) and a group on which the MC-06 process was performed and that was cooled with dry ice but was not injected with the physiological saline solution (non-saline injected group: 3 pigs), was compared macroscopically and histopathologically.

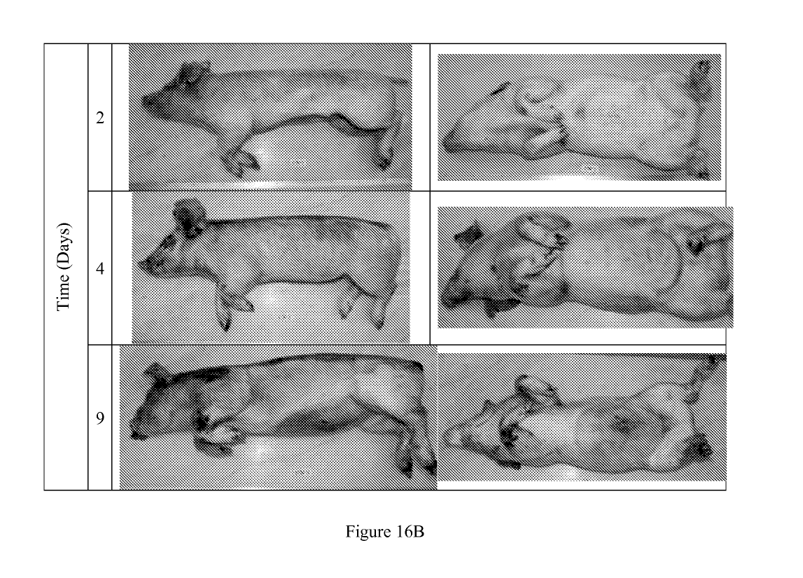

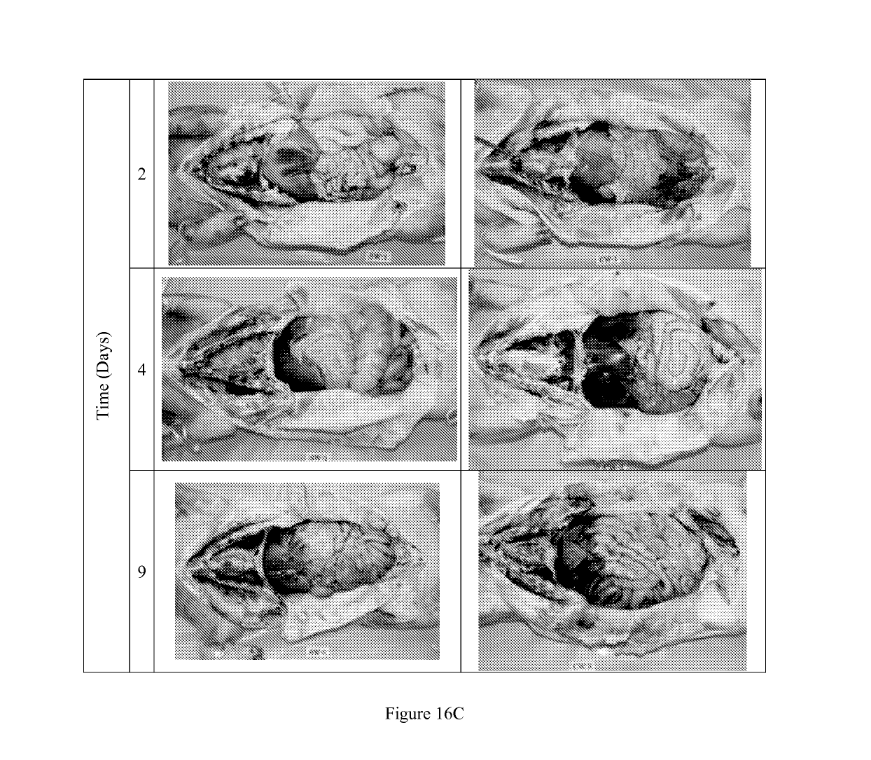

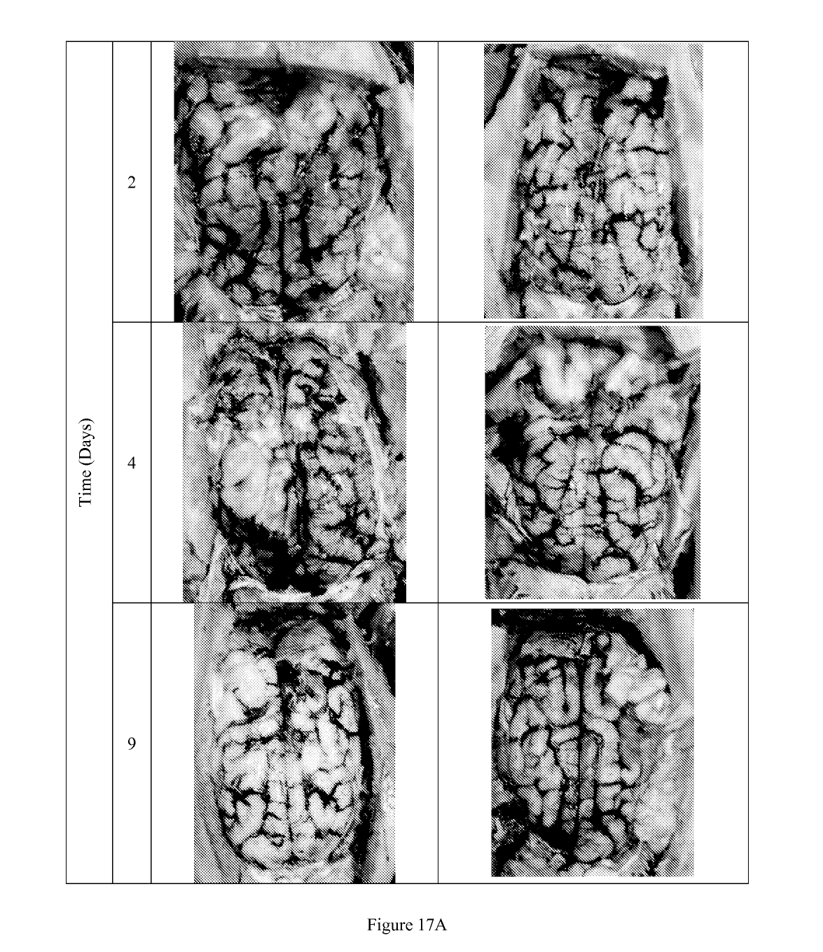

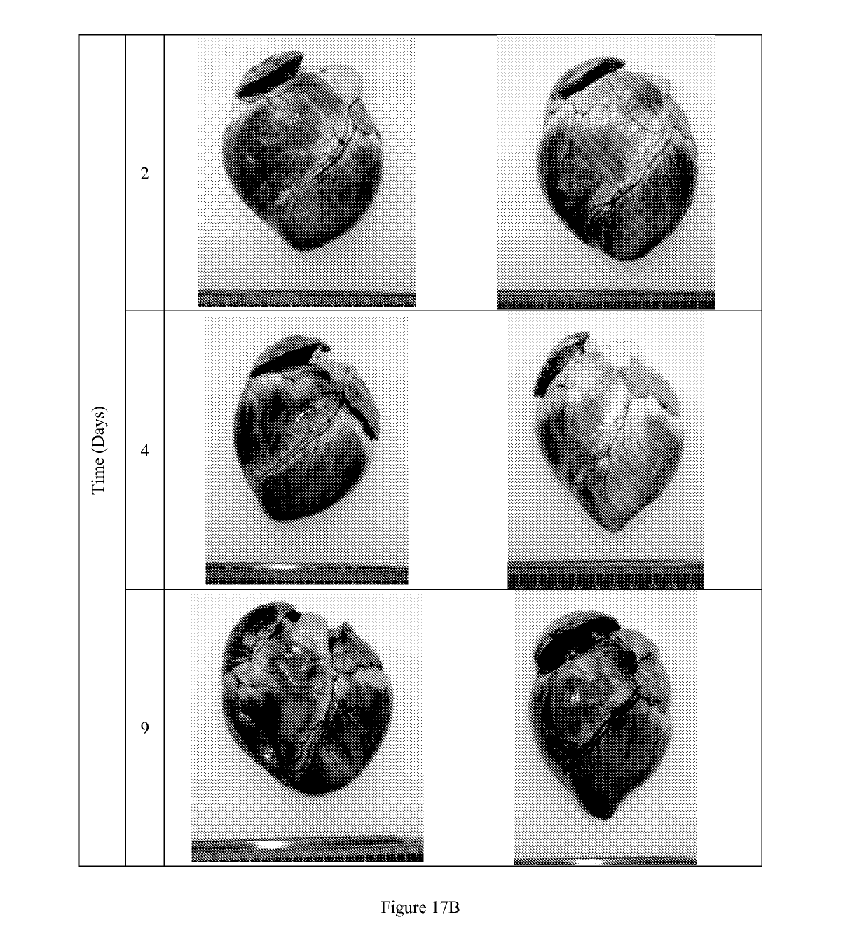

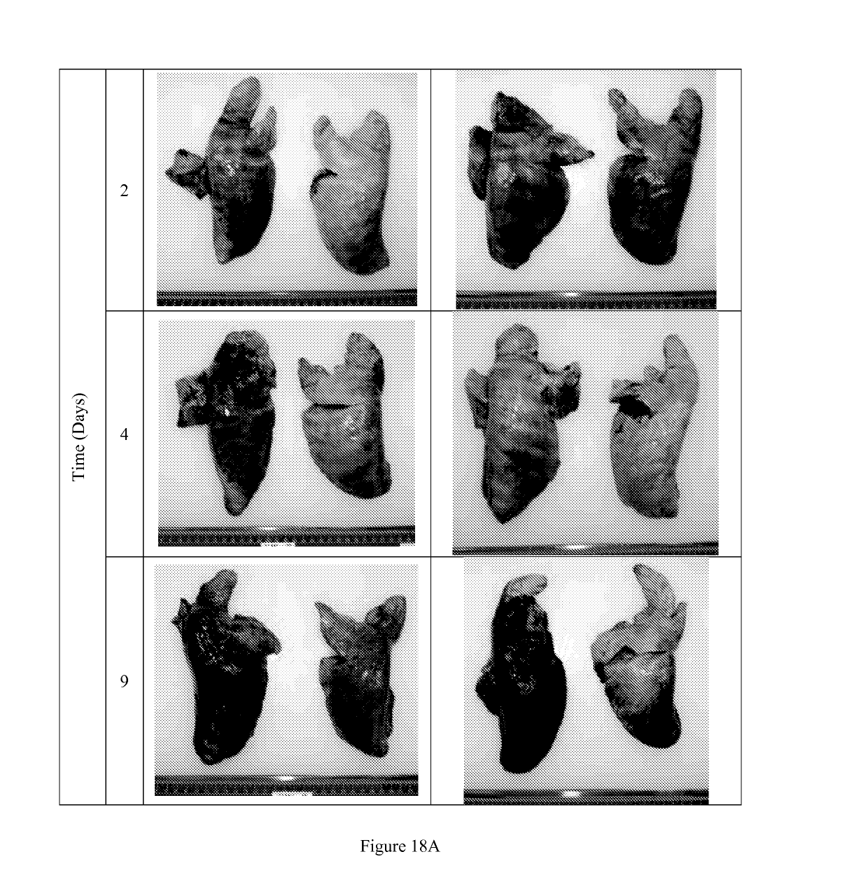

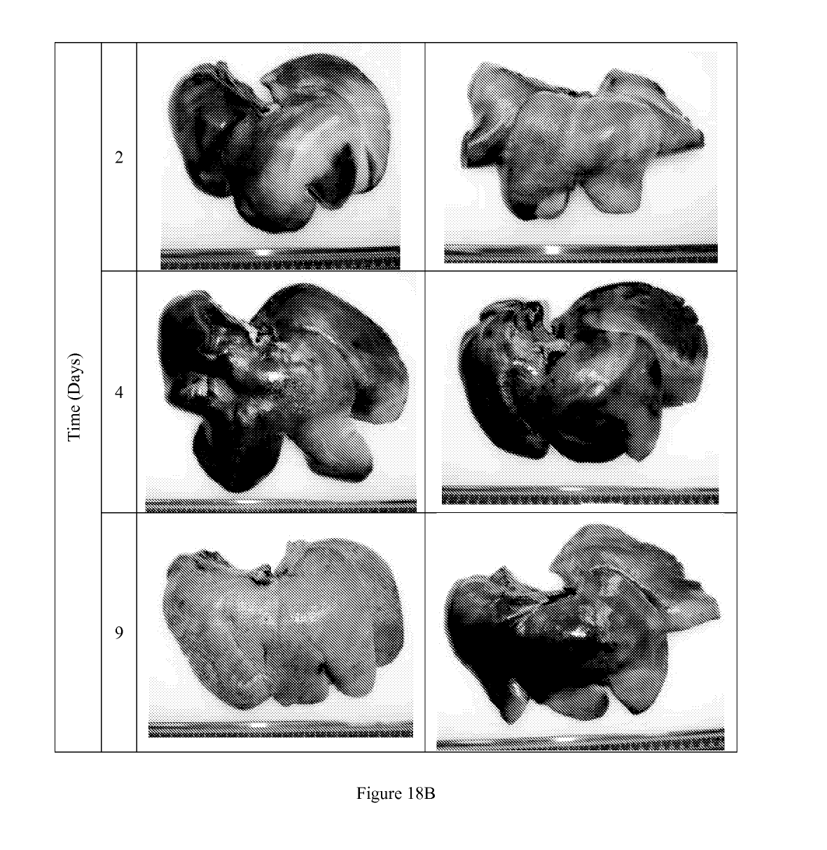

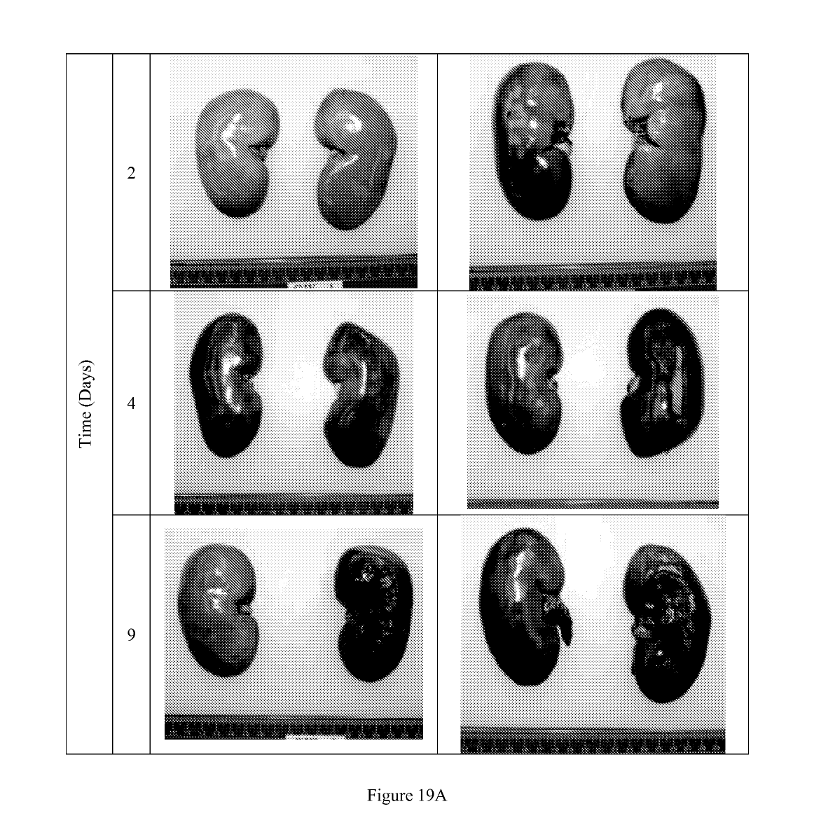

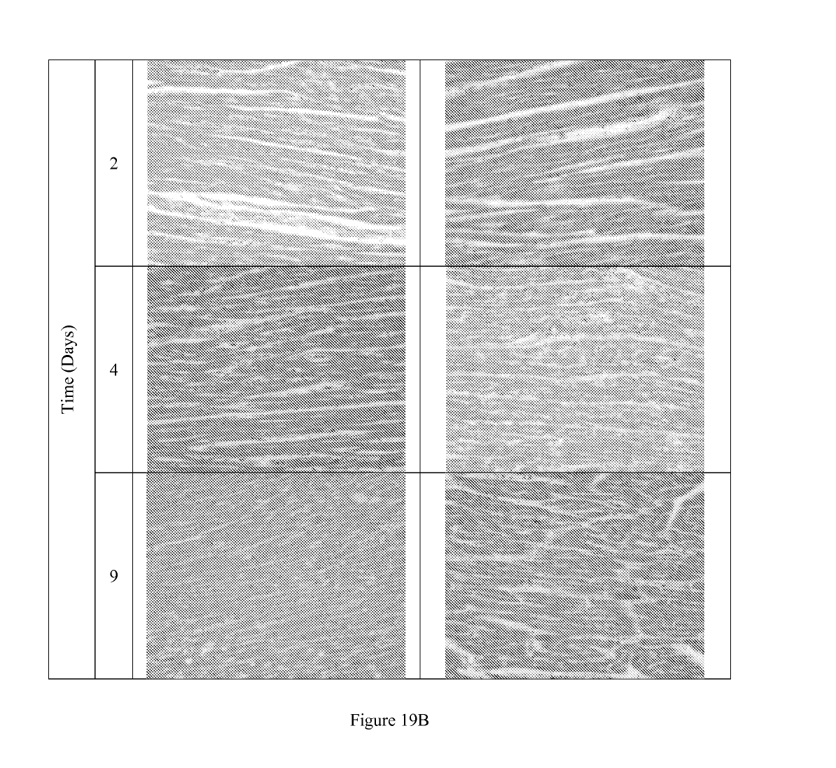

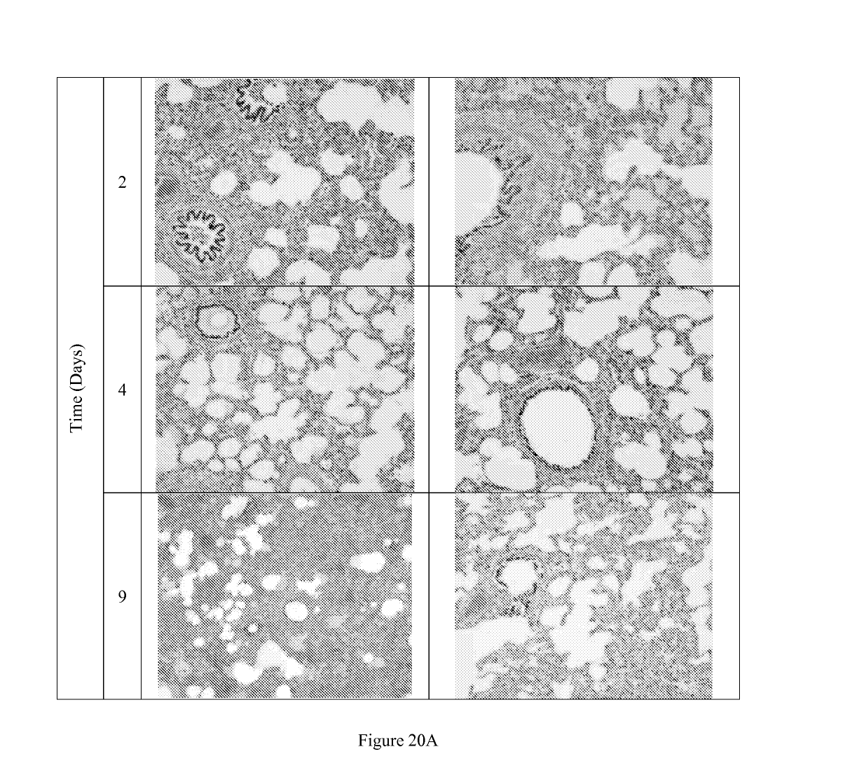

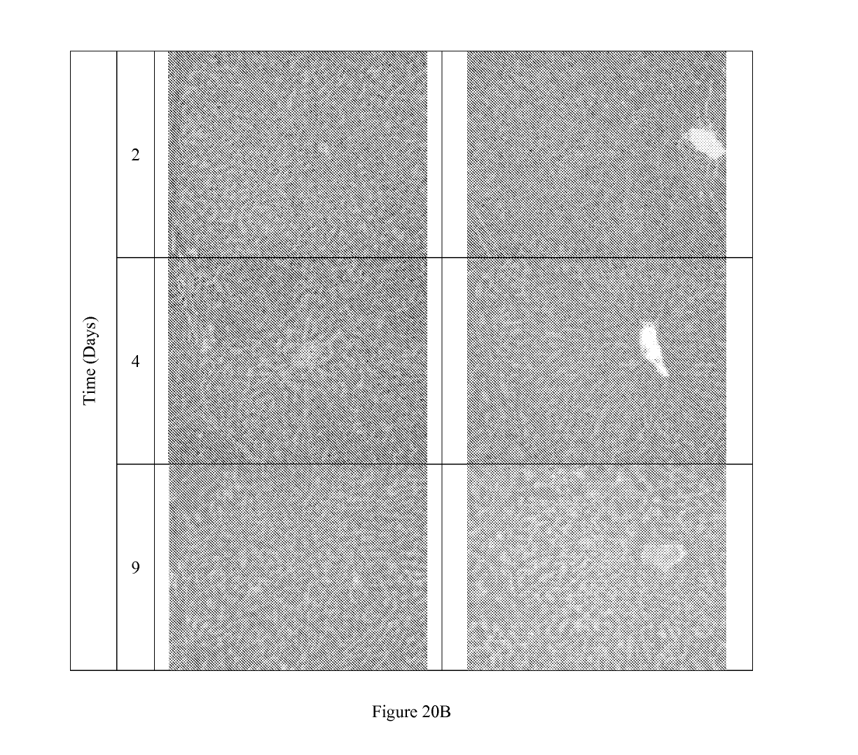

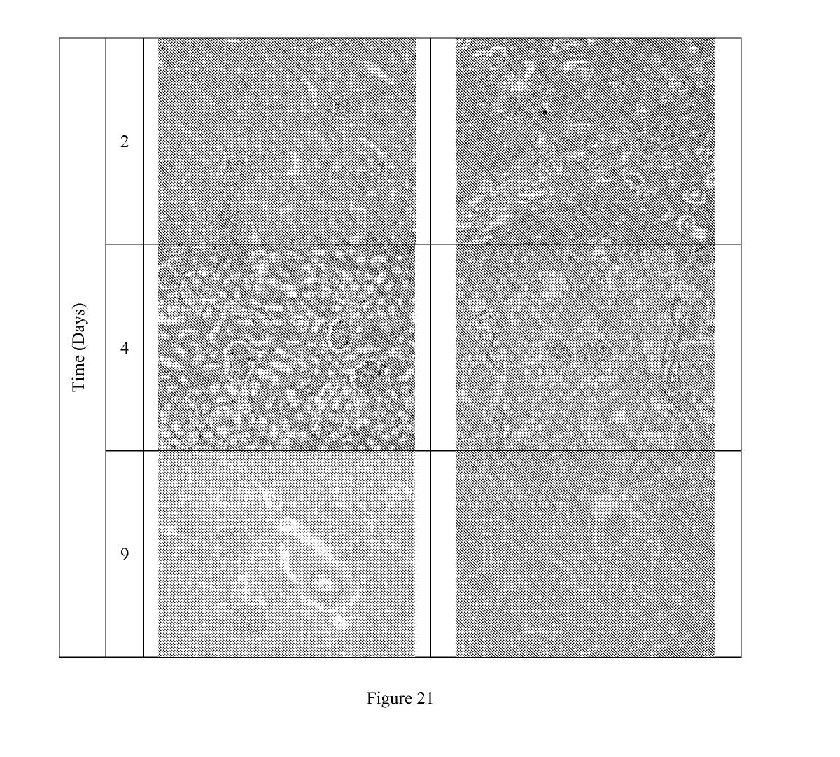

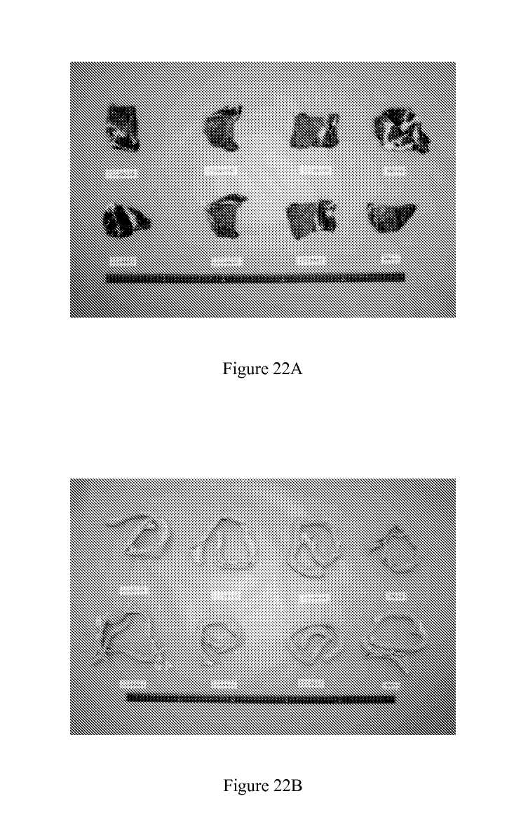

Results are illustrated in FIG. 16A through FIG. 21. The state of preservation of entire corpses and of internal organs was improved by the injection of the physiological saline solution into the abdominal cavities. It is thought that this is because heat is applied more uniformly and more effectively by the injection of the physiological saline solution. Corpse preservation capability is increased dramatically when compared to that of comparative experiment 1.

Note that, just as with comparative experiments 1 and 2, there were individuals where skin discoloration and fragility, diaphragm and intestinal tract ruptures and alveoli of the visceral pleura of the lungs were seen.

Thermal melting of the tissue caused by the applied heat progresses with the MC-06 process alone, but the state of preservation of the corpse is improved by cooling the corpse with dry ice (20 kg/20-30 kg) immediately after the MC-06 process. This condition also compared well with a case where only cooling was performed without performing the MC-06 process.

Additionally, the state of preservation of a corpse to which the physiological saline solution was added before the MC-06 is even better, probably because heat is applied uniformly thereto.

However, skin discoloration and fragility of a portion making contact with a high-frequency electrode plate (this is presumed to be caused by heat), diaphragm and intestinal tract rupture and formation of alveoli of the visceral pleura of the lungs were, to some degree, commonly observed in cases where the MC-06 process was performed. Since conditions are different for humans and pigs, there is adequate reason to think that the MC-06 settings used this time were possibly too strong for pigs.

At the time of the autopsies of the aforementioned comparative experiments 1 through 3, intestinal tracts of the large intestine ileocecal regions were wiped with sterile swabs, these were used to produce laboratory cultures of intestinal bacteria and the impact on intestinal bacteria typified by E. coli was examined.

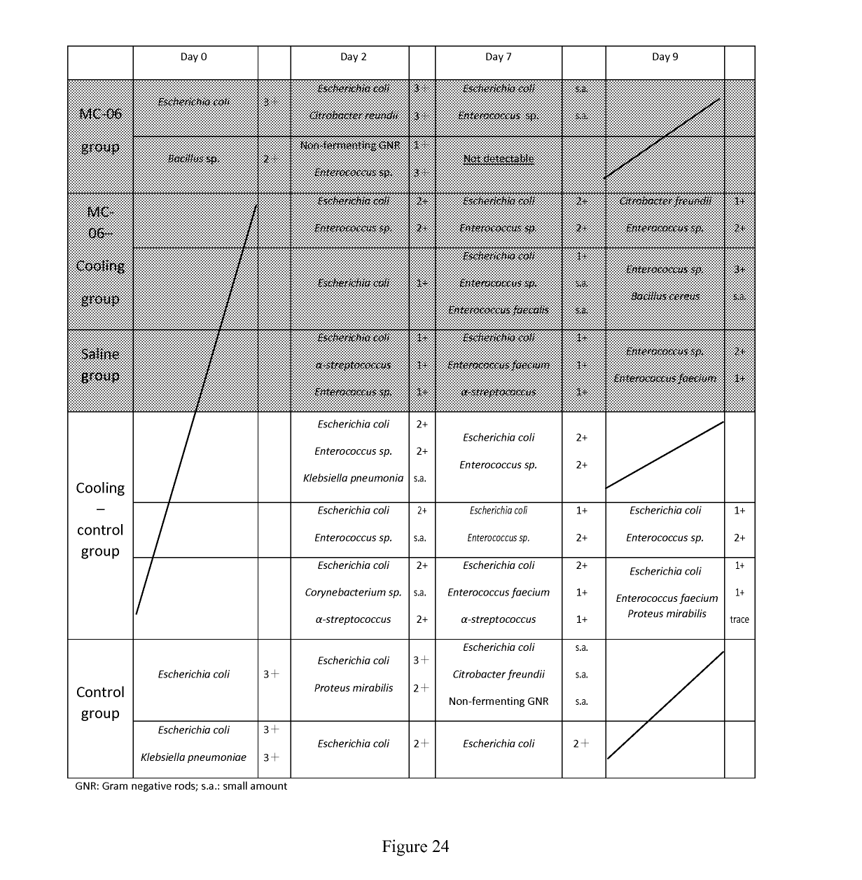

The results are illustrated in FIG. 24. When groups for which the MC-06 process was performed are compared to groups for which the process was not performed, there is no difference in the types of germs detected, but the groups for which the MC-06 process was performed showed a tendency to have smaller numbers of bacterial colonies. There were also individuals for which no E. coli was discovered after the MC-06 process.

During comparative experiment 1, the concentrations of pentobarbital, which was used during anesthesia, present in blood, urine and organs of the MC-06 group and the comparison group were compared.

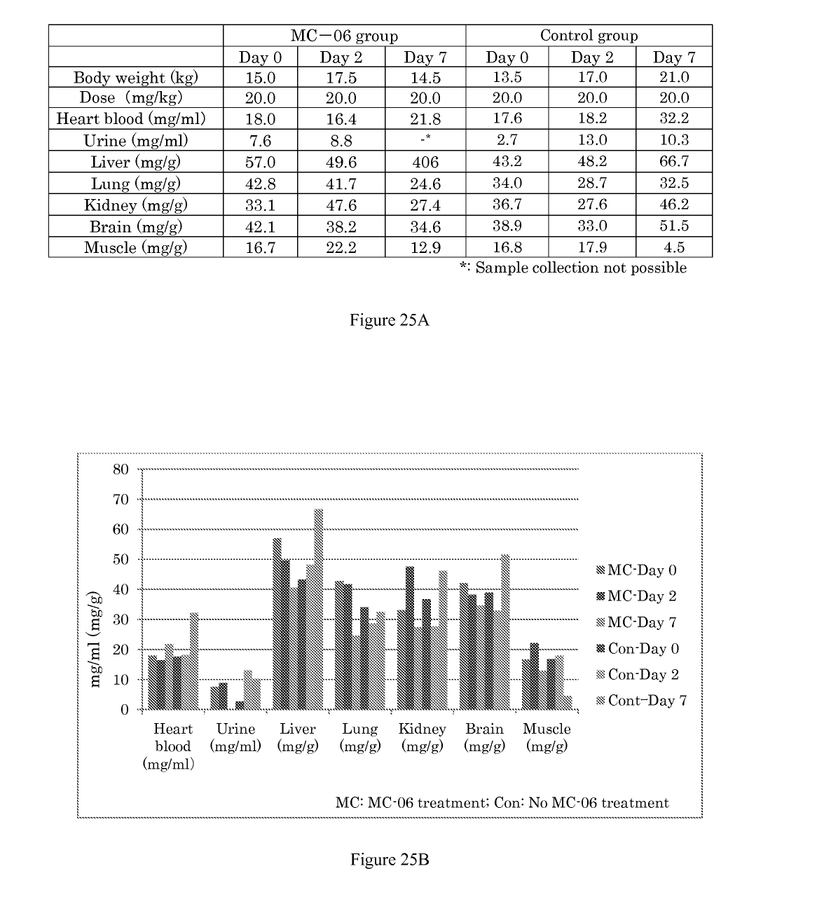

The results are illustrated in FIG. 25. Note that in the histogram in FIG. 25, the data of 0 days after MC, 2 days after MC, 7 days after MC, 0 days after target, 2 days after target and 7 days after target, reading from the left, correspond to the various internal organs respectively.

While the same thing cannot necessarily be said of agent across the board, looking at these results reveals no specific trend and, in particular, the MC-06 process cannot be considered to exert an impact on the change in the concentration of the pentobarbital.

During comparative experiment 3, blood taken before death and heart blood taken from the pigs during autopsies were used to compare the degree of detection of STR-type*) loci S0005 and SW911 (before death, two days after death, four days after death and nine days after death) (*Rajeev Kaul, Atar Singh, R. K. Vijh, M. S. Tantia and Rahul Behl. Evaluation of the genetic variability of 13 microsatellite markers in native Indian pigs. JOURNAL OF GENETICS 80(3), 149-153, 2001).

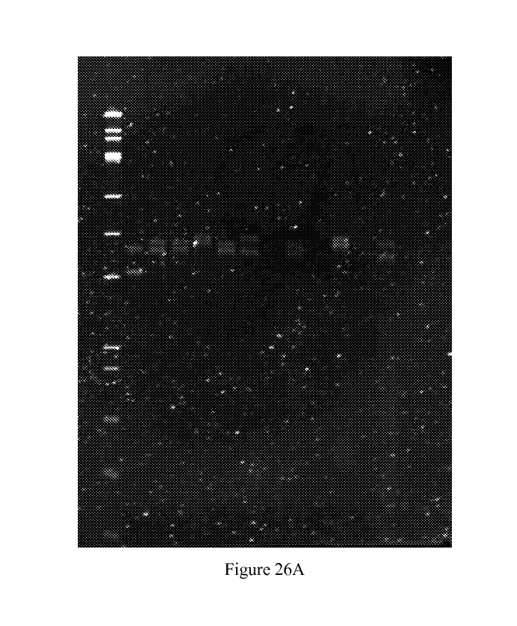

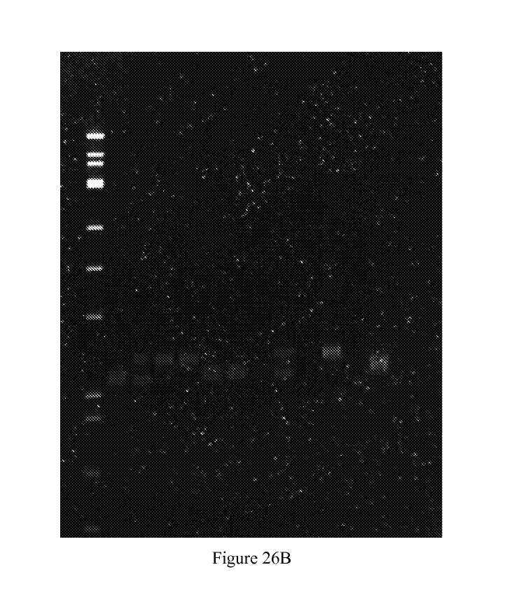

As illustrated in FIG. 26, it was possible to detect both loci in the saline injected group one week after death, but for the non-saline injected group, S0005 was no longer detectable two days after death and SW911 was no longer detectable four days after death.

Based on this, it can be shown that in terms of changes in DNA, as well as in terms of macroscopic and histopathological changes, the state of preservation of the corpse is improved by injecting the physiological saline solution into the abdominal cavity.

The sterilizing action of ozone gas is applied in many settings such as cleaning and sterilizing drinking water, cleaning vegetables, sterilizing aquaculture ponds for fish and the like. When sterilizing using conventional chemicals, the impact on the environment must be considered, but ozone can easily be detoxified through the use of a pyrolysis device and thus can be called a disinfecting method that is easy on the natural environment. In addition, ozone can also be said to eliminate odors.

Outer surface sterilization is performed using ozone gas and ultraviolet rays during the MC-06 process and if the elimination of odors can be achieved through this process, such can be called a side benefit of the MC-06 process in that there are sometimes corpses with strong foul odors. Even the use of ozone water in which ozone has been dissolved makes it possible to eliminate odors in a similar way. If ozone water is used, it may be possible to clean and deodorize the corpse at the same time relatively easily without producing the airtight space of the MC-06 process. With this type of situation in mind, the degree to which foul odors and the like would be reduced by exposure to ozone was examined.

The odors of the outer surfaces of pigs one, four and nine days after death (two pigs each: six pigs total) were measured and then the odors were measured again after exposure to ozone through MC-06 and the measurements were compared.

Note that before being exposed to ozone, the pigs were sprayed and wetted with purified water (use of ozone water is assumed) and then exposed to ozone gas three times, each time being exposed to ozone gas with a concentration of between 50 and 70 ppm for 15 minutes, and the odors of the corpses were measured each time.

A mini XP-329m portable odor sensor (High sensitivity tin oxide-based sintered hot wire type semiconductor type: New Cosmos Electric Co., Ltd.) was used to measure the odor. Note that for the odor measurement using the XP-329m, the concentration (strength) of an odor was displayed as a number based on a relative value with the odor of purified air being 0.

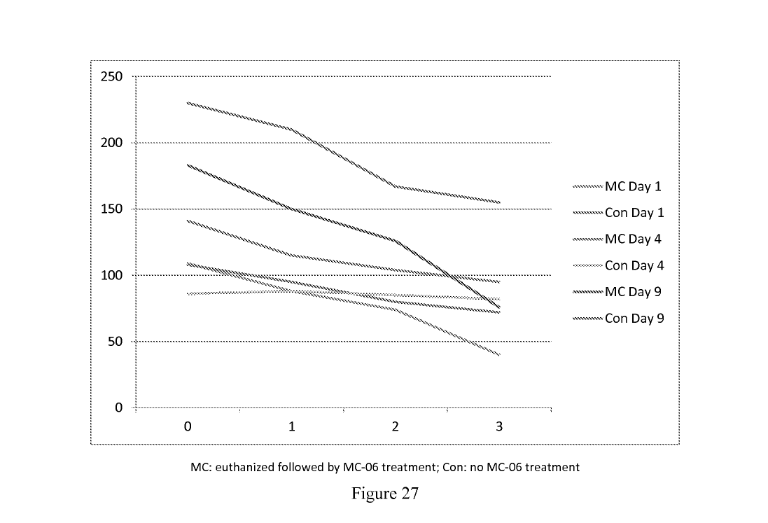

FIG. 27 illustrates the measured values graphically. As illustrated in FIG. 27, it was seen that the odor of the corpses had a tendency to increase over the course of time after death. Furthermore, the odor decreased based on the number of times the corpses were exposed to ozone. From a sensory perspective as well, there was a sense that an odor peculiar to pigs was also largely reduced along with the foul odor.

As the course of time after death grows longer and longer, foul and nasty odors and the like are generated, which is one of the barriers to handling such a corpse. These results show strong odor elimination due to exposure to ozone and that even stronger odor elimination can be achieved by increasing the number of exposures. However, there are cases where the difference between the second exposure and the third exposure is not significant and thus approximately two exposures to ozone are generally considered to be adequate.

Ozone gas and ultraviolet rays are used to sterilize the corpse outer surface during the MC-06 process (exposure to ozone and irradiation of ultraviolet rays are performed simultaneously) and a deodorizing action is also achieved, thus by exposing the corpse to ozone through the MC-06 process prior to handling, it is expected that it will be possible to safely and easily handle the corpse. In practice, there are cases where it is preferable to deodorize the corpse if possible. In these cases, by flushing the corpse with ozone water into which ozone has been dissolved rather than using difficult to handle ozone gas, the deodorizing and sterilizing actions of ozone are expected and easier and safer corpse handling will surely become possible.

However, on the other hand, some toxic poisonings have characteristic odors and on rare occasions those odors can provide clues to the cause of death. And thus adequate caution must be given to the fact that the deodorizing action of ozone can also eliminate odors that are needed in diagnosing the cause of death.

In addition, ozone possesses a strong oxidizing action. And so it is necessary to use materials for equipment such as examination, mortem inspection and autopsy tables that are corrosion resistant. Furthermore, while there is no problem when the airtight MC-06 processing system is used, it must not be forgotten that using highly concentrated ozone water in an open space is dangerous.

While performing the MC-06 process after injecting the physiological saline solution into the abdominal cavity was effective in comparative experiment 3 of embodiment 1, the following experiment was performed assuming a case using a saline solution of a higher concentration.

Pork (approximately 5 cm×5 cm×1 cm) and pig intestine (between approximately 5 and 10 cm) were placed in plastic bags containing purified water, a 10% saline solution, a 20% saline solution and a 30% saline solution and then heated at 50° C. for 30 minutes and were left to sit either as is or in a state of having been removed from the liquid and placed in a bag, and the state of postmortem changes was observed macroscopically.

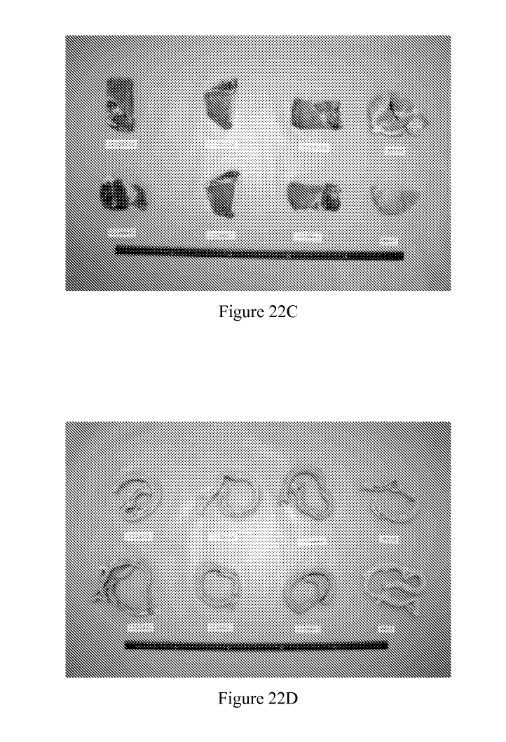

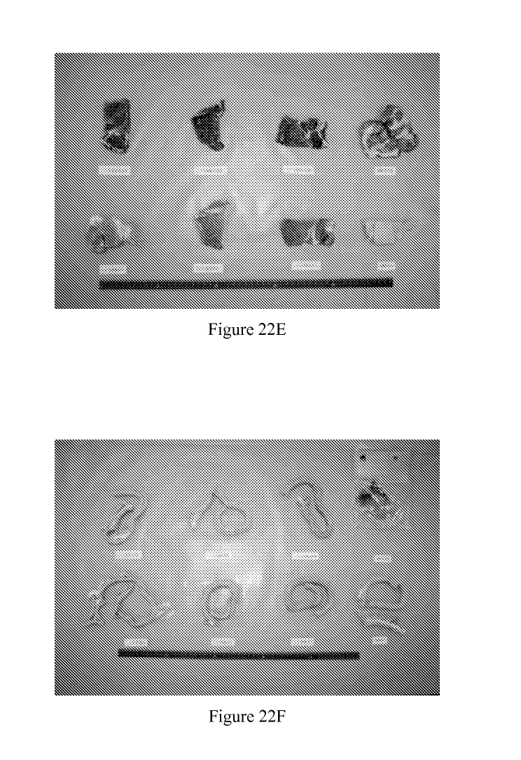

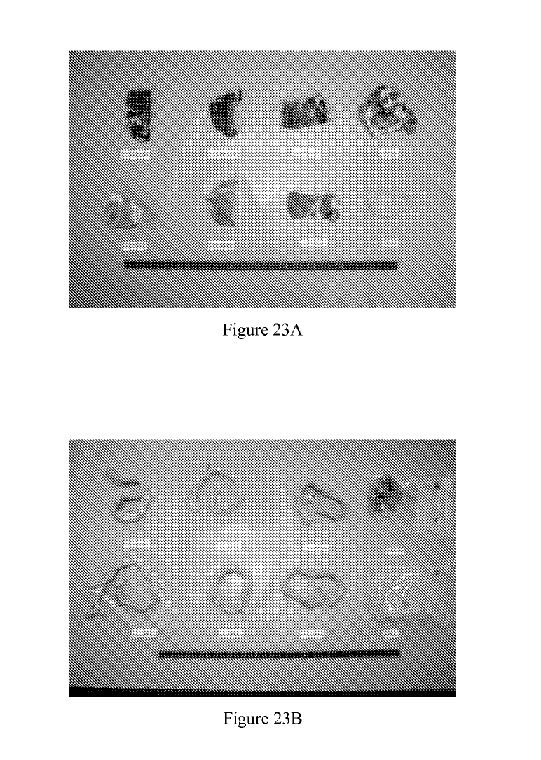

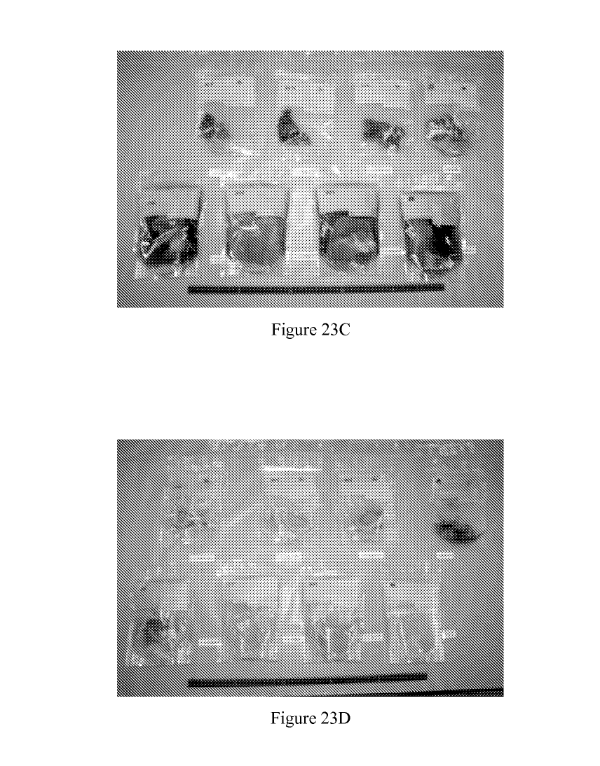

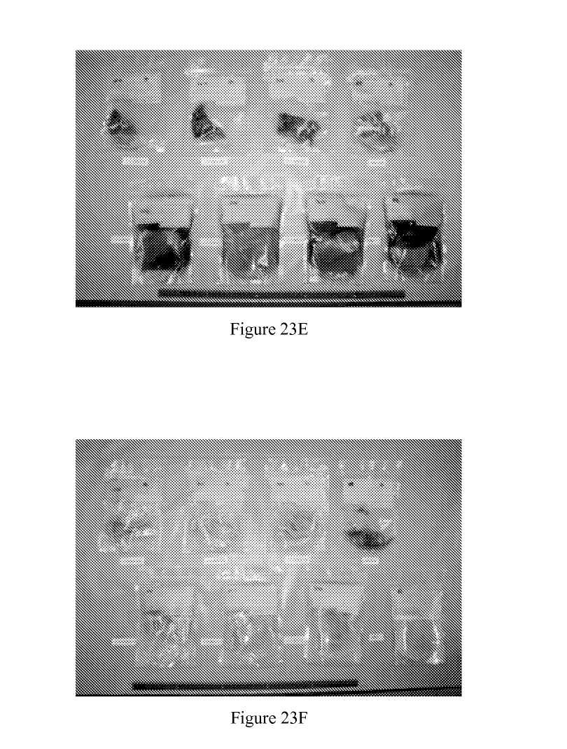

As illustrated in FIG. 22 and FIG. 23, those heated in the 20% and 30% saline solution were in a good state of preservation and, in particular, those preserved as is in the saline solution did not dissolve even after 29 days (approximately four weeks).

Note that the surfaces of the intestines left to sit in the saline solution were wiped with sterile swabs and the bacterial cultures were examined, and only small amounts of staphylococcal bacteria (CNS) were detected on those in the 20% and 30% saline solution even after approximately a week and this condition continued for those in the 30% saline solution even after 29 days had passed. These facts suggest that it is possible to improve the state of preservation even more by using a highly concentrated solution such as a saline solution with a concentration of between 20 and 30% for injection into the abdominal cavity.

The main constituent of change of the MC-06 process is the change generated by heating and the main constituent of that change is heat fixing. By quickly cooling after processing, the impact of thermal melting thereafter is reduced and thus it is estimated that the corpse can be preserved for approximately one week thereafter without further cooling and without replacing the blood with a preservative solution.

Furthermore, it is suggested that injecting the physiological saline solution into the abdominal cavity before the MC-06 process further improves the state of preservation thereof and that using a highly concentrated saline solution of between 20 and 30% at that time makes preservation over an even longer period of time possible.

Note that diaphragm and intestinal tract rupture and formation of alveoli of the visceral pleura of the lungs are sometimes seen and it is considered possible that these types of artifacts are added by the MC-06 process. Generally, this is considered to be due to the fact that the conditions used this time were too strong for pigs, but the fact that this could occur even in humans must be taken into consideration.

However, if CT imaging and the like are performed before the MC-06 process and the fact recorded that those types of changes did not exist in the corpse originally, any confusion that they are damage from before death can be avoided.

Furthermore, the possibility that all types of small objects and forensic material remaining on the corpse surface will be destroyed by blowing ozone gas on and irradiating the corpse surface with ultraviolet rays using the MC-06 process can also be overcome by collecting adequate material beforehand.

In addition, showing a use for deodorizing foul odors and the like using ozone water and considering the sterilizing action of ozone suggests that processing the corpse with ozone water before an autopsy or during an examination or mortem inspection can make easier and safer corpse handling possible. However, there are problems in that ozone causes corrosion and presents a health hazard to living bodies thus some further examination is required.

The corpse processing vehicle of the present invention is well suited as equipment for preventing decay by processing a corpse at the scene of a disaster area and the like.

To summarize, regarding the exemplary embodiments of the present invention as shown and described herein, it will be appreciated that a corpse decay prevention method and corpse processing vehicle are disclosed in at least one embodiment. Because the principles of the invention may be practiced in a number of configurations beyond those shown and described, it is to be understood that the invention is not in any way limited by the exemplary embodiments, but is able to take numerous forms without departing from the spirit and scope of the invention. It will also be appreciated by those skilled in the art that the present invention is not limited to the particular devices and processes disclosed, but may instead entail other functionally comparable devices and processes, now known or later developed, without departing from the spirit and scope of the invention. Furthermore, the various features of each of the above-described embodiments may be combined in any logical manner and are intended to be included within the scope of the present invention.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. A corpse processing vehicle comprising a vehicle mounting equipment used for preventing decay of a corpse, wherein:
the equipment comprises:
loading and unloading means for loading and unloading the corpse in the vehicle through an opening of the vehicle, and
corpse heating means where the corpse is supplied from the loading and unloading means;
the corpse heating means comprises:
delivery means for delivering the corpse to and from the loading and unloading means, and
a heating unit that electromagnetically heats the corpse from the inside to raise a temperature of the tissue to at least a temperature that solidifies proteins that configure the tissue of the corpse interior and that can hold the temperature of the tissues to at least a temperature where protein solidifies; and
the loading and unloading means comprises:
a transporting unit to deliver the corpse to and from the delivery means of the corpse heating means;
sterilizing means for sterilizing prior to supplying the loaded corpse to the corpse heating means; and
corpse cooling means for cooling a corpse heated by the corpse heating means.

2. The corpse processing vehicle according to claim 1, wherein:
the loading and unloading means comprises:
a case provided with a space for receiving a corpse inside and having an opening for loading and unloading the corpse to and from the space; and
a lid section provided that can move near to and away from the opening of the case and that blocks the space inside the case from the outside when near the opening of the case;
wherein:
the loading and unloading means is configured to implement sterilization of a corpse by the sterilizing means and cooling of a corpse by the corpse cooling means when the space inside the case is blocked to the outside by the lid section.

3. The corpse processing vehicle according to claim 2, wherein the sterilizing means has a function to supply ozone and nebulized water droplets into the case while the space inside the case is blocked to the outside by the lid section.

4. The corpse processing vehicle according to claim 3, further comprising a physiological saline solution supply means wherein, prior to heating a corpse by the corpse heating means, a physiological saline solution is injected into the digestive tract or into a cavity between the abdominal wall and the digestive tract of a corpse.

5. The corpse processing vehicle according to claim 4, further comprising:
a blocking wall provided with a gate between the loading and unloading means and the corpse heating means for continuously blocking therebetween; and
a shielding member, provided on an inner side of the vehicle, having an electromagnetic wave shielding effect.

6. The corpse processing vehicle according to claim 2, further comprising a physiological saline solution supply means wherein, prior to heating a corpse by the corpse heating means, a physiological saline solution is injected into the digestive tract or into a cavity between the abdominal wall and the digestive tract of a corpse.

7. The corpse processing vehicle according to claim 6, further comprising:
a blocking wall provided with a gate between the loading and unloading means and the corpse heating means for continuously blocking therebetween; and
a shielding member, provided on an inner side of the vehicle, having an electromagnetic wave shielding effect.

8. The corpse processing vehicle according to claim 2, further comprising:
a blocking wall provided with a gate between the loading and unloading means and the corpse heating means for continuously blocking therebetween; and
a shielding member, provided on an inner side of the vehicle, having an electromagnetic wave shielding effect.

9. The corpse processing vehicle according to claim 1, wherein the sterilizing means has a function to supply ozone and nebulized water droplets into the case while the space inside the case is blocked to the outside by the lid section.

10. The corpse processing vehicle according to claim 1, further comprising a physiological saline solution supply means wherein, prior to heating a corpse by the corpse heating means, a physiological saline solution is injected into the digestive tract or into a cavity between the abdominal wall and the digestive tract of a corpse.

11. The corpse processing vehicle according to claim 1, further comprising:
a blocking wall provided with a gate between the loading and unloading means and the corpse heating means for continuously blocking therebetween; and
a shielding member, provided on an inner side of the vehicle, having an electromagnetic wave shielding effect.

12. A method for preventing decay of a corpse, the corpse decay prevention method comprising:
injecting a physiological saline solution into the digestive tract of a corpse or into a cavity between the abdominal wall and the digestive tract of a corpse;
raising a temperature of a tissue to at least a temperature where proteins that configure the tissue of the corpse interior solidify by electromagnetically heating a corpse from the inside;
holding a temperature of the tissue to at least a temperature where protein solidifies;
cooling a corpse after electromagnetic heating; and
contacting the corpse with air containing ozone and nebulized water droplets.

13. A method for preventing decay of a corpse, the corpse decay prevention method comprising:
the corpse decay prevention method comprising:
injecting a physiological saline solution into the digestive tract of a corpse or into a cavity between the abdominal wall and the digestive tract of a corpse;
raising a temperature of a tissue to at least a temperature where proteins that configure the tissue of the corpse interior solidify by electromagnetically heating a corpse from the inside;
holding a temperature of the tissue to at least a temperature where protein solidifies; and
cooling a corpse after electromagnetic heating.
